(19) United States
(12) Patent Application Publication
(10) Pub. No.: US 2025/0224696 A1
(43) Pub. Date: Jul. 10, 2025

(54) PROCESS CARTRIDGE

(71) Applicant: ZHUHAI DINGHUI TECHNOLOGY CO., LTD., Zhuhai (CN)

(72) Inventors: Shengkui ZHAO, Zhuhai (CN); Dongming LIN, Zhuhai (CN); Hangyu PENG, Zhuhai (CN); Xia LIU, Zhuhai (CN)

(73) Assignee: ZHUHAI DINGHUI TECHNOLOGY CO., LTD., Zhuhai (CN)

(21) Appl. No.: 19/094,748

(22) Filed: Mar. 28, 2025

Related U.S. Application Data
(63) Continuation-in-part of application No. PCT/CN2023/123059, filed on Oct. 1, 2023.

(30) Foreign Application Priority Data
Oct. 1, 2022 (CN) 202222636008.X
Oct. 10, 2022 (CN) 202222669133.0
Nov. 1, 2022 (CN) 202222907750.X
Nov. 3, 2022 (CN) 202222933490.3
Nov. 15, 2022 (CN) 202223048288.9
Nov. 22, 2022 (CN) 202223109554.4
Feb. 7, 2023 (CN) 202320189488.1
Feb. 23, 2023 (CN) 202320309772.8

(51) Int. Cl. G03G 21/18; G03G 21/16

(52) U.S. Cl. CPC G03G 21/186; G03G 21/1633; G03G 21/1814; G03G 21/1867

(57) ABSTRACT

A process cartridge includes a photosensitive drum, a charging member, a charging electrode assembly, and a chip. The charging electrode assembly includes a power receiving portion for receiving electrical power and a power transmission portion for making electrical connection with the charging member. The chip includes a storage portion for storing process cartridge information and an electrical contact portion electrically connected to the storage portion. The electrical contact portion and the power receiving portion are disposed at the upper portion of a non-drive end and are exposed upward from the housing.

### CROSS-REFERENCE TO RELATED APPLICATIONS

This application is a continuation-in-part of International Application No. PCT/CN2023/123059, filed on Oct. 1, 2023, which claims priority to Chinese Patent Application No. 202222636008.X, filed on Oct. 1, 2022; Chinese Patent Application No. 202222669133.0, filed on Oct. 10, 2022; Chinese Patent Application No. 202222907750.X, filed on Nov. 1, 2022; Chinese Patent Application No. 202222933490.3, filed on Nov. 3, 2022; Chinese Patent Application No. 202223048288.9, filed on Nov. 15, 2022; Chinese Patent Application No. 202223109554.4, filed on Nov. 22, 2022; Chinese Patent Application No. 202320189488.1, filed on Feb. 7, 2023; and Chinese Patent Application No. 202320309772.8, filed on Feb. 23, 2023. All of the aforementioned applications are incorporated herein by reference in their entireties.

### TECHNICAL FIELD

The present application relates to the field of electrophotographic imaging, particularly to a process cartridge detachably mounted in an electrophotographic imaging device.

### BACKGROUND

Chinese Patent Application Publication CN113574469A (hereinafter referred to as the referenced patent application) discloses a force output member (main assembly side driving force transmission unit) 203 disposed in an imaging device M. As shown in FIG. 2E (FIG. 43 of the referenced patent application), the force output member 203 has a rotational axis M1 and includes a driving force output member (drum drive coupling) 180 for outputting driving force and a braking force output member (including a first braking engagement member 204 and a second braking engagement member 208) for outputting braking force. When the force output member 203 outputs driving force to the driving force receiving member X4 described below, the braking force output member is driven by the driving force output member 180 to rotate together with the driving force output member.

As shown in FIG. 2G (FIG. 45 of the referenced patent application), along the direction of the rotational axis M1, the driving force output member 180 is provided at its two ends with a driving force output surface (drive transmission surface) 180d and a flange portion 180a, respectively. As shown in FIG. 2E, the first braking engagement member 204 has a flange portion 204a and a coupling engagement portion 204b protruding from the flange portion 204a. The coupling engagement portion 204b is configured to protrude in a claw-like manner toward the rotational axis M1 of the force output member. The second braking engagement member 208 also includes a flange portion 208a and a coupling engagement portion 208b protruding from the flange portion 208a. The coupling engagement portion 208b is also configured to protrude in a claw-like manner toward the rotational axis M1 of the force output member. In the radial direction perpendicular to the rotational axis M1, the first braking engagement member 204 is positioned radially outward from the second braking engagement member 208, the coupling engagement portion 204b is positioned radially outward from the coupling engagement portion 208b. Both the first braking engagement member 204 and the second braking engagement member 208 can rotate simultaneously about the rotational axis M1.

The Chinese Patent Application Publication CN113574469A further discloses a rotating member 21 equipped with a conventional driving force receiving member X4 as shown in FIG. 1. The rotating member 21 and the driving force receiving member X4 are suitable for use in a conventional process cartridge. The process cartridge includes a first unit and a second unit that are mutually engaged. The first unit includes a first unit housing and a first rotating member rotatably mounted in the first unit housing. The second unit includes a second unit housing and a second rotating member rotatably mounted in the second unit housing. The driving force receiving member X4 is disposed at one longitudinal end of the process cartridge and drives at least one of the first rotating member and the second rotating member to rotate.

Taking the rotation of the second rotating member 21 about its rotational axis L21 as an example, as shown in FIG. 1, the driving force receiving member X4 is engaged to the second rotating member 21 and includes a chassis X42, a base X43, and an engagement portion X44. Along the direction of the rotational axis L21, the chassis X42, the base X43, and the engagement portion X44 are arranged in sequence. The engagement portion X44 includes a central column X45 and a driving force receiving portion X46 extending radially outward from the central column X45. The driving force receiving portion X46 is provided with a guide surface X463 extending helically around the rotational axis L21 in the circumferential direction, and a driving surface X464 and a braking surface X465 disposed adjacent to the guide surface. Along the direction of the rotational axis L21, the guide surface X463 is positioned axially upstream of the braking surface X465.

During the installation process of the process cartridge, the guide surface X463 abuts against at least the coupling engagement portion 208b of the second braking engagement member 208 to guide the driving force receiving portion X46 to enter between the driving force output surface 180d and the coupling engagement portions 208b/204b. During operation of the process cartridge, the driving force output surface 180d outputs driving force to the driving surface X464 to drive the rotating member 21 to rotate, and the braking force output member applies braking force to the braking surface X465 downstream in the rotational direction of the driving force receiving portion X46.

The process cartridge generally includes a chip for storing process cartridge information and a charging electrode assembly for powering a charging member. The chip has an electrical contact portion for connecting with the imaging device, and the charging electrode assembly includes a charging electrode for connecting with the imaging device. The charging electrode and electrical contact portion are typically disposed at the two ends or different directions of the process cartridge. This design leads to increased complexity of the electrical components in the imaging device that match the process cartridge, and the charging electrode or electrical contact portion near the drive end is prone to being affected by the movement of the imaging device's drive head during operation, thus affecting the stability of the electrical connection.

### SUMMARY

The present application provides a process cartridge to further develop the aforementioned technology, with the specific solution as follows.

A process cartridge detachably installable in an imaging device comprises: a driving force receiving member; a housing, comprising a drive end where the driving force receiving member is provided and an opposite non-drive end; a photosensitive drum, rotatably mounted in the housing, wherein the photosensitive drum is driven by driving force received by the driving force receiving member, and the driving force receiving member is exposed from the drive end; a charging member, configured to charge the photosensitive drum; a charging electrode assembly, comprising a power receiving portion configured to receive electrical power and a power transmission portion configured to make electrical connection with the charging member, wherein the power receiving portion is electrically connected to the power transmission portion; a chip, comprising a storage portion for storing process cartridge information and an electrical contact portion electrically connected to the storage portion; and a developing roller, rotatably mounted in the housing, with the photosensitive drum and the developing roller being mounted in a lower side of the housing; wherein the electrical contact portion and the power receiving portion are disposed at an upper portion of the non-drive end, and are exposed upward from the housing.

In some embodiments, the housing comprises a first unit housing, a second unit housing, and a second end cover mounted at the non-drive end, wherein the second end cover engages with the first unit housing and the second unit housing, the electrical contact portion is disposed on the second end cover, and the charging electrode assembly is disposed on the second unit housing.

In some embodiments, the electrical contact portion and the power receiving portion both face upward.

In some embodiments, the housing comprises a first unit housing, a second unit housing, and a second end cover mounted at the non-drive end, wherein the second end cover engages with the first unit housing and the second unit housing, the second end cover is further provided with an electrical contact cavity, and at least the power receiving portion is positioned in the electrical contact cavity.

In some embodiments, the imaging device further comprises a door cover, and a top plate provided with a power output member and a contact pin, wherein the contact pin and the power output member are both exposed downward, before the door cover of the imaging device closes, the top plate does not abut against the process cartridge, when the door cover closes, the top plate abuts against the process cartridge, the electrical contact portion achieves electrical connection with the contact pin, and the power receiving portion also achieves electrical connection with the power output member.

In some embodiments, the power receiving portion contacts either a lower conductive surface or a side conductive surface of the power output member.

In some embodiments, the process cartridge further comprises a toggle member configured to toggle the power receiving portion, causing the power receiving portion to transition from a first state where the power receiving portion is not capable of receiving power to a second state where the power receiving portion is capable of receiving power.

In some embodiments, the charging member is rotatably supported by a bracket on the housing, a spring is disposed between the bracket and the housing, and through pushing of the spring, the charging member maintains contact with the photosensitive drum.

In some embodiments, the process cartridge further comprises a friction member disposed adjacent to and in contact with the charging member, wherein the friction member extends along a direction of a rotational axis of the driving force receiving member, and the charging member is rotatably supported by a bracket on the housing.

In some embodiments, the charging member is driven to rotate by a friction force between a surface of the photosensitive drum and a surface of the charging member, and when the charging member loses its drive source, a friction force between the friction member and the charging member forces the charging member, which continues to rotate due to inertia, to stop rotating.

In some embodiments, the friction member is an elastic component.

In some embodiments, the friction member is configured as a sponge body.

In some embodiments, the imaging device further comprises a force output member, the force output member comprises a driving portion and a braking portion, and the braking portion is rotatable together with the driving portion, the driving force receiving member comprises a driving force receiving portion and an auxiliary member, the driving force receiving portion is configured to engage with the force output member to receive driving force, the auxiliary member is configured to rotate freely about a rotational axis of the driving force receiving member, and at least a portion of the auxiliary member is configured to separate the driving portion and the braking portion in a rotational direction of the force output member.

In some embodiments, the auxiliary member is movably disposed along a direction of the rotational axis of the driving force receiving member.

In some embodiments, the driving force receiving member further comprises an engagement portion and a base that are mutually engaged, the driving force receiving portion is disposed in the engagement portion, the base is cylindrical and comprises a base outer wall and a base inner wall arranged radially and forming a spacing groove therebetween, and a portion of the auxiliary member is accommodated in the spacing groove.

In some embodiments, the driving force receiving member further comprises a main body portion provided with the driving force receiving portion, at least a portion of the main body portion is accommodated by the auxiliary member; the auxiliary member is provided with a limited portion, and the main body portion is provided with a limiting portion configured to engage with the limited portion.

In some embodiments, the auxiliary member comprises a carrier body and a separation member protruding from the carrier body, the limited portion is disposed on the carrier body or the separation member, the auxiliary member is sleeved on the outside of the main body portion, the separation member is provided with a guide surface, and during a process of the driving force receiving member moving toward the force output member, the guide surface abuts against the braking portion and forces the braking portion to move away from the driving portion along the rotational direction.

In some embodiments, the separation member is further provided with a hook surface configured to engage with the braking portion, the hook surface is configured to prevent the force output member from separating from the driving force receiving member.

In some embodiments, the separation member comprises a separation member body and a tip portion that are mutually engaged, the guide surface is disposed on the separation member body, and the tip portion extends from the guide surface in a direction further away from the carrier body.

In some embodiments, the auxiliary member is sleeved on the housing.

In some embodiments, when the driving force receiving member and the force output member are fully engaged, at least a portion of the auxiliary member enters a space between the driving portion and the braking portion, and the driving force receiving portion engages with the driving portion or the braking portion.

### BRIEF DESCRIPTION OF THE DRAWINGS

FIG. 1 is a perspective view of a rotating member equipped with a conventional driving force receiving member.

FIG. 2A is a perspective view of a conventional force output member.

FIG. 2B is a partial perspective view of the conventional force output member.

FIG. 2C is a partial perspective view of the conventional force output member with the braking force output member hidden.

FIG. 2D is a top view when viewed along the direction of the rotational axis of the conventional force output member.

FIG. 2E is an exploded schematic perspective view of the conventional force output member.

FIG. 2F is a sectional schematic view of the conventional force output member.

FIG. 2G is a perspective view of the conventional force output member.

FIG. 2H is a structural schematic view of the conventional force output member.

FIG. 2I is a developed view of the conventional force output member engaged with the driving force receiving member.

FIGS. 3A and 3B are perspective views of the process cartridge according to the present application.

FIG. 4A is a perspective view of a photosensitive drum with the driving force receiving member according to Embodiment 1 of the present application.

FIG. 4B is a perspective view of a first type of driving force receiving member according to Embodiment 1 of the present application.

FIG. 4C is a side view when viewed along the direction of the rotational axis of the first type of driving force receiving member according to Embodiment 1 of the present application.

FIG. 5A is a perspective view of the driving force receiving member according to Embodiment 2 of the present application.

FIG. 5B is a side view when viewed along the direction of the rotational axis of the driving force receiving member according to Embodiment 2 of the present application.

FIG. 6 is a perspective view of the driving force receiving member according to Embodiment 3 of the present application.

FIG. 7 is an exploded schematic view of the driving force receiving member according to Embodiment 4 of the present application.

FIG. 8A is a perspective view of the driving force receiving member according to Embodiment 4 of the present application beginning to engage with the force output member.

FIG. 8B is a perspective view of the driving force receiving member according to Embodiment 4 of the present application after engaging with the force output member.

FIG. 8C is a side view when viewed in a direction perpendicular to the rotational axis of the driving force receiving member according to Embodiment 4 of the present application after engaging with the force output member.

FIG. 9A is a perspective view of the driving force receiving member according to Embodiment 5 of the present application.

FIG. 9B is a side view when viewed along the direction of the rotational axis of the driving force receiving member according to Embodiment 5 of the present application.

FIG. 10 is a perspective view of the driving force receiving member according to Embodiment 5 of the present application after engaging with the force output member.

FIG. 11 is a sectional view taken along the direction AA in FIG. 10 after the driving force receiving member according to Embodiment 5 of the present application engages with the force output member.

FIG. 12A is an exploded schematic view of the driving force receiving member according to Embodiment 6 of the present application.

FIG. 12B is an exploded schematic view after the driving force receiving member in a modified embodiment of Embodiment 6 is separated from the second unit housing.

FIG. 12C is a sectional view taken along the direction DD in FIG. 12B.

FIG. 13A is a perspective view of the driving force receiving member according to Embodiment 6 of the present application.

FIG. 13B is a side view when viewed along the direction of the rotational axis of the driving force receiving member according to Embodiment 6 of the present application.

FIGS. 14A and 14B are views illustrating the state of the driving force receiving member according to Embodiment 6 of the present application after engaging with the force output member.

FIG. 15 is a perspective view of the driving force receiving member according to Embodiment 7 of the present application.

FIG. 16 is a view illustrating the state of the driving force receiving member according to Embodiment 7 of the present application after engaging with the force output member.

FIG. 17 is a perspective view of the driving force receiving member according to Embodiment 8 of the present application.

FIGS. 18A-18D are schematic views of the engagement process of the driving force receiving member according to Embodiment 8 of the present application with the force output member.

FIG. 19 is a perspective view of the driving force receiving member according to Embodiment 9 of the present application.

FIG. 20 is a perspective view of the second unit according to Embodiment 10 of the present application after hiding some components.

FIG. 21 is a sectional view of a process cartridge having the second unit according to Embodiment 10 of the present application, taken along a plane perpendicular to the rotational axis of the photosensitive drum.

FIG. 22A is a perspective view of the driving force receiving member according to Embodiment 11 of the present application.

FIG. 22B is a side view when viewed in a direction perpendicular to the rotational axis of the driving force receiving member according to Embodiment 11 of the present application.

FIG. 23A is a schematic view illustrating the state when viewing the driving force receiving member and the force output member in a direction perpendicular to the rotational axis of the driving force receiving member according to Embodiment 11 of the present application before the driving force receiving member engages with the force output member.

FIG. 23B is a schematic view illustrating the state when viewing the driving force receiving member and the force output member in a direction perpendicular to the rotational axis of the driving force receiving member, with the auxiliary member hidden, before the driving force receiving member according to Embodiment 11 of the present application engages with the force output member.

FIG. 23C is a perspective view of the driving force receiving member and the force output member with the auxiliary member hidden before the driving force receiving member according to Embodiment 11 of the present application engages with the force output member.

FIG. 24A is a schematic view illustrating the state when viewing the driving force receiving member and the force output member in a direction perpendicular to the rotational axis of the driving force receiving member according to Embodiment 11 of the present application when the driving force receiving member begins to engage with the force output member.

FIG. 24B is a schematic view illustrating the state when viewing the driving force receiving member and the force output member in a direction perpendicular to the rotational axis of the driving force receiving member, with the auxiliary member hidden, when the driving force receiving member according to Embodiment 11 of the present application begins to engage with the force output member.

FIG. 24C is a perspective view of the driving force receiving member and the force output member with the auxiliary member hidden when the driving force receiving member according to Embodiment 11 of the present application begins to engage with the force output member.

FIG. 25A is a schematic view illustrating the state when viewing the driving force receiving member and the force output member in a direction perpendicular to the rotational axis of the driving force receiving member according to Embodiment 11 of the present application during the engagement process of the driving force receiving member with the force output member.

FIG. 25B is a schematic view illustrating the state when viewing the driving force receiving member and the force output member in a direction perpendicular to the rotational axis of the driving force receiving member, with the auxiliary member hidden, during the engagement process of the driving force receiving member according to Embodiment 11 of the present application with the force output member.

FIG. 25C is a perspective view of the driving force receiving member and the force output member with the auxiliary member hidden during the engagement process of the driving force receiving member according to Embodiment 11 of the present application with the force output member.

FIG. 26A is a schematic view illustrating the state when viewing the driving force receiving member and the force output member in a direction perpendicular to the rotational axis of the driving force receiving member according to Embodiment 11 of the present application after the completion of engagement of the driving force receiving member with the force output member.

FIG. 26B is a schematic view illustrating the state when viewing the driving force receiving member and the force output member in a direction perpendicular to the rotational axis of the driving force receiving member, with the auxiliary member hidden, after the completion of engagement of the driving force receiving member according to Embodiment 11 of the present application with the force output member.

FIG. 26C is a perspective view of the driving force receiving member and the force output member with the auxiliary member hidden after the completion of engagement of the driving force receiving member according to Embodiment 11 of the present application with the force output member.

FIG. 27 is an exploded schematic view of components of the driving force receiving member according to Embodiment 12 of the present application.

FIG. 28 is a sectional view of the driving force receiving member according to Embodiment 12 of the present application taken along a plane extending through its rotational axis.

FIG. 29 is an exploded schematic view of the driving force receiving member after the driving force receiving member according to Embodiment 13 of the present application is separated from the drive end cover.

FIG. 30 is a sectional view taken along the direction EE extending through the rotational axis of the driving force receiving member according to Embodiment 13 of the present application.

FIG. 31 is a view illustrating the state after the driving force receiving member according to Embodiment 14 of the present application has been separated from the drive end cover.

FIG. 32 is a sectional view taken along the direction EE extending through the rotational axis of the driving force receiving member according to Embodiment 14 of the present application.

FIG. 33 is an exploded schematic view of the driving force receiving member according to Embodiment 15 of the present application.

FIG. 34 is a perspective view of the drive end cover according to Embodiment 15 of the present application.

FIG. 35 is a sectional view taken along the direction EE extending through the rotational axis of the driving force receiving member according to Embodiment 15 of the present application.

FIG. 36 is a perspective view of the process cartridge when viewed from the non-drive end of the process cartridge according to Embodiment 16 of the present application.

FIG. 37 is a side view when viewed from left to right in the left-right direction after hiding some components of the process cartridge according to Embodiment 16 of the present application.

FIG. 38 is a perspective view of the top plate in the imaging device applicable to the process cartridge according to the present application.

FIG. 39A is a simplified side view when viewed from left to right in the left-right direction before the process cartridge according to Embodiment 16 of the present application contacts the top plate.

FIG. 39B is a simplified side view when viewed from left to right in the left-right direction after the process cartridge according to Embodiment 16 of the present application contacts the top plate.

FIG. 40 is a perspective view of some components in the process cartridge according to Embodiment 17 of the present application.

FIG. 41 is a partial perspective view of the process cartridge according to Embodiment 17 of the present application after contacting the top plate.

FIG. 42 is a perspective view of some components in the process cartridge according to Embodiment 18 of the present application.

FIG. 43 is a simplified side view when viewed from left to right in the left-right direction after hiding some components before the process cartridge according to Embodiment 18 of the present application contacts the top plate.

FIG. 44 is a simplified side view when viewed from left to right in the left-right direction after the process cartridge according to Embodiment 18 of the present application contacts the top plate.

FIG. 45 is a perspective view of some components in the process cartridge according to Embodiment 19 of the present application.

FIG. 46 is a simplified side view when viewed from left to right in the left-right direction after the process cartridge according to Embodiment 19 of the present application contacts the top plate.

FIGS. 47A and 47B are simplified side views when viewed from left to right in the left-right direction before and after the process cartridge according to Embodiment 20 of the present application contacts the top plate, respectively.

FIGS. 48A and 48B are simplified side views when viewed from left to right in the left-right direction before and after the process cartridge according to Embodiment 21 of the present application contacts the top plate, respectively.

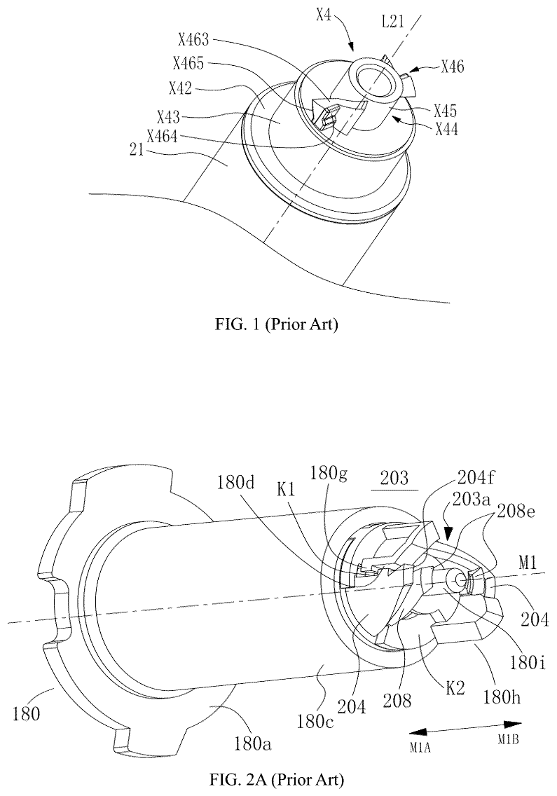

### DETAILED DESCRIPTION OF THE EMBODIMENTS

The embodiments of the present application will be described in detail below with reference to the drawings.

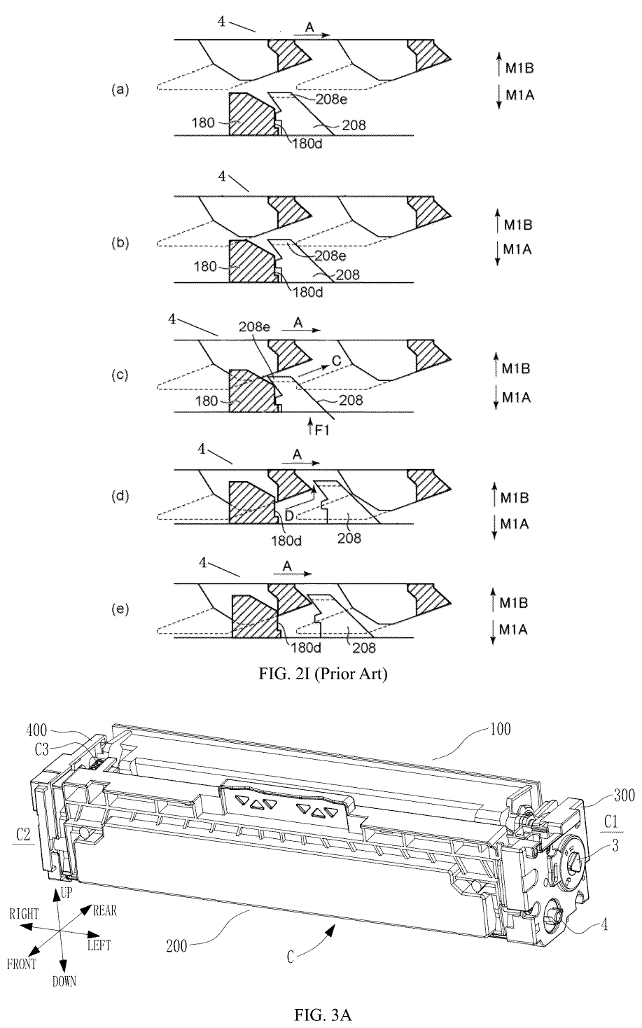

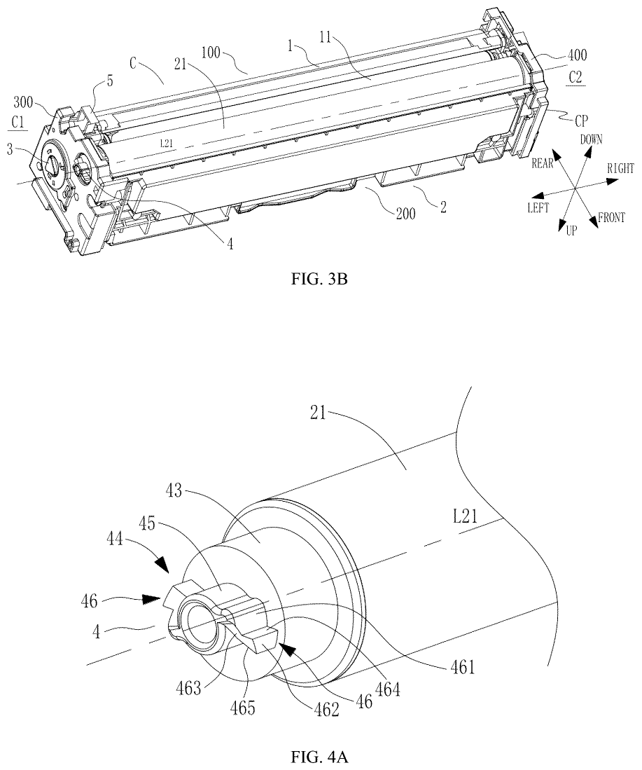

FIGS. 3A and 3B are perspective views of a process cartridge C according to the present application. The process cartridge C includes a first unit 100 and a second unit 200 that are mutually engaged. The first unit 100 includes a first unit housing 1 and a first rotating member 11 rotatably mounted in the first unit housing 1. The second unit 200 includes a second unit housing 2 and a second rotating member 21 rotatably mounted in the second unit housing 2. A driving force receiving member 4 is disposed at one longitudinal end of the process cartridge C and drives at least one of the first rotating member 11 and the second rotating member 21 to rotate.

It is understood that the first rotating member 11 and/or the second rotating member 21 may be directly or indirectly driven by the driving force receiving member 4; the process cartridge C may simultaneously include the first unit 100 and the second unit 200, or it may include only either the first unit 100 or the second unit 200. The developer is contained in the first unit housing 1, the side where the driving force receiving member 4 is disposed is designated as the drive end C1, and the opposite end is designated as the non-drive end C2. A drive end cover/first end cover 300 is mounted at the drive end C1, and the driving force receiving member 4 is exposed from the drive end C1. A non-drive end cover/second end cover 400 is mounted at the non-drive end C2. The first unit 100 and the second unit 200 may be engaged through the first end cover 300 and the second end cover 400, or they may be engaged by means such as pins, snap-fits, etc. The first end cover 300 and the second end cover 400 may either be part of the first unit 100 or the second unit 200, or they may be components independent of the first unit 100 or the second unit 200, as long as they can engage the first unit 100 and the second unit 200. The first end cover 300 engages with the first unit housing 1 and the second unit housing 2, and the second end cover 400 also engages with the first unit housing 1 and the second unit housing 2. The housing of the process cartridge C includes the first unit housing 1, the second unit housing 2, the first end cover 300, and the second end cover 400. The rotating members include a photosensitive drum 21 and a developing roller 11 that can be rotatably disposed in the housing.

The first rotating member 11 may be a developing roller rotatably disposed in the first unit housing 1, and the second rotating member 21 may be a photosensitive drum rotatably disposed in the second unit housing 2. However, the first rotating member 11 and the second rotating member 21 may also be other components in the process cartridge that need to rotate, such as a charging member 24 for charging the photosensitive drum, a supply member 102 for supplying developer to the developing roller, an agitating member for agitating the developer, etc., as long as the driving force receiving member 4 can receive driving force from the force output member disposed in the imaging device and drive the rotating member to rotate. In other words, the photosensitive drum 21, charging member 24, developing roller 11, supply member 102, agitating member, etc., which are rotatably mounted in the process cartridge C, may collectively be designated as rotating members. The driving force receiving member 4 drives the rotating member to rotate by receiving driving force from the device, and thus the combination of the rotating member and the driving force receiving member 4 may be collectively designated as a rotation assembly.

During operation of the process cartridge C, the photosensitive drum 21 contacts the developing roller 11, and the developing roller 11 supplies developer to the photosensitive drum 21. Hereinafter, the driving force receiving member is designated by the numeral 4. The driving force receiving member 4 is fixedly mounted at one longitudinal end of the rotating member, and thus the driving force receiving member 4 and the rotating member share the same rotational axis.

For convenience of description herein, with respect to the process cartridge C, the direction from the side where the photosensitive drum 21 and the developing roller 11 are mounted pointing towards the side where the photosensitive drum 21 and the developing roller 11 are not mounted is designated as the upward direction, and the direction opposite to the upward direction is the downward direction. The direction from the first unit 100 towards the second unit 200 is the forward direction, and the direction opposite to the forward direction is the rearward direction. The side receiving the driving force is the left side, and the side opposite to the left side is the right side. The process cartridge C is installed into the device from top to bottom along the up-down direction. The left side is the drive end C1, and the right side is the non-drive end C2. The first end cover 300 is mounted at the drive end C1, and the second end cover 400 is mounted at the non-drive end C2. The first driving force receiving member 3 (also referred to as the “developing driving force receiving member 3”) for receiving driving force for the developing roller 11 and the driving force receiving member 4 for receiving driving force for the photosensitive drum 21 are both exposed from the first end cover 300.

Furthermore, the process cartridge C further includes a return member C3 disposed between the first unit 100 and the second unit 200. When a separation force is applied to the process cartridge, the return member C3 undergoes elastic deformation. When the separation force is removed, the return member C3 releases the elastic force, and the developing roller 11 and the photosensitive drum 21 return to a position of mutual contact.

Hereinafter, the description will use the example where the driving force receiving member 4 is directly mounted at the end of the photosensitive drum 21.

### Force Output Member in the Imaging Device

To ensure the subsequent description clarity, it is necessary to reference the drawings of the referenced patent application mentioned in the background art for further describing the force output member 203.

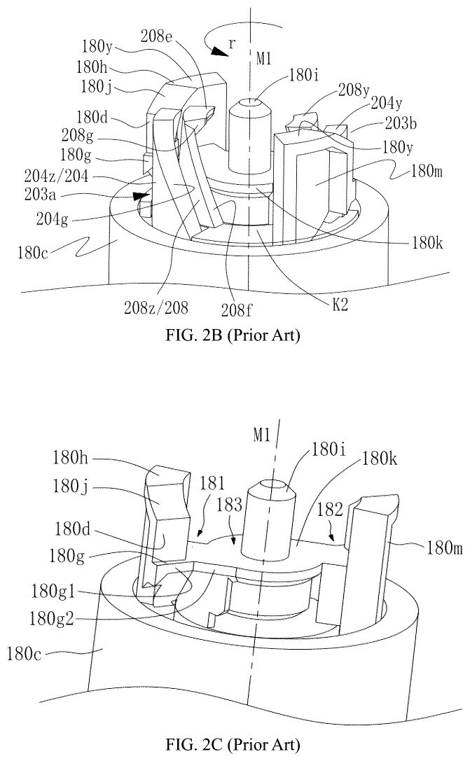

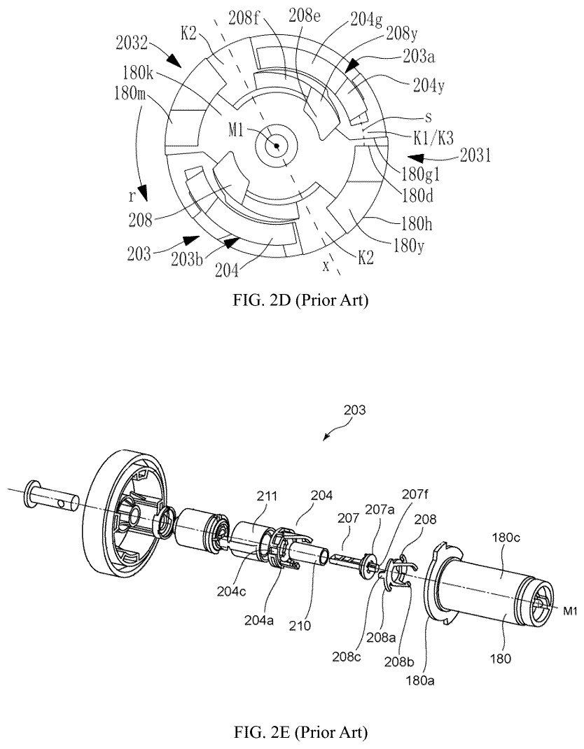

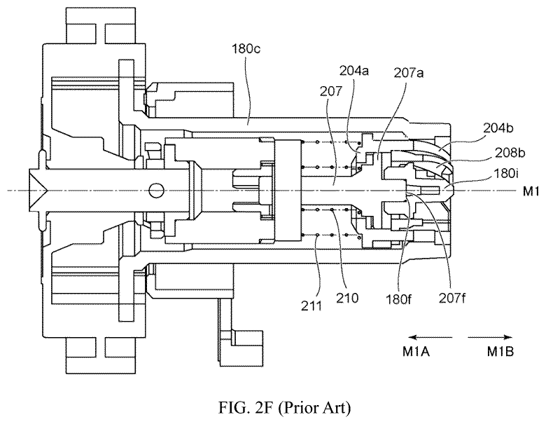

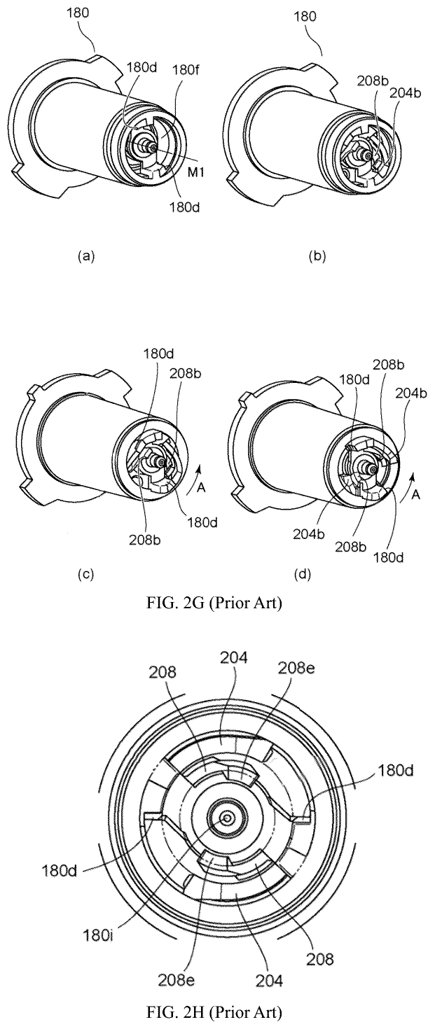

FIG. 2A is a perspective view of a conventional force output member; FIG. 2B is a partial perspective view of the conventional force output member; FIG. 2C is a partial perspective view of the conventional force output member with the braking force output member hidden; FIG. 2D is a top view when viewed along the direction of the rotational axis of the conventional force output member.

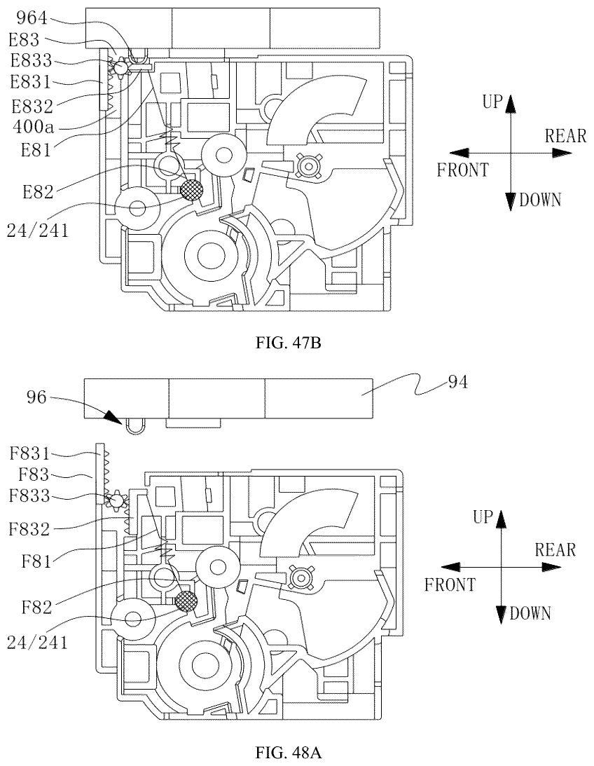

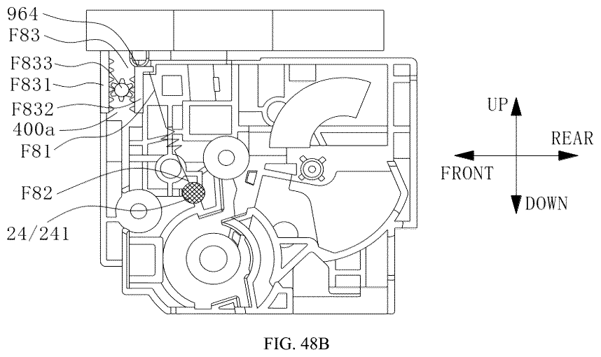

As shown in FIGS. 2A-2D, the driving force output member 180 includes a cylindrical portion 180c and a flange portion 180a and a driving portion 180h positioned at the two ends of the cylindrical portion 180c, respectively. The braking force output member includes a first braking engagement member 204 and a second braking engagement member 208 that are mutually engaged. As shown in FIG. 21 (FIG. 48 of the referenced patent application) and FIGS. 19 and 21B, the driving force output member 180 and the braking force output member can rotate in the same rotational direction r about the rotational axis M1, and the braking force output member can rotate together with the driving force output member 180. Before the process cartridge C is installed in the device, the driving force output member 180 and the braking force output member partially overlap.

The driving force output member 180 includes a first driving force output portion 180h and a second driving force output portion 180m arranged opposite to each other in the radial direction of the force output member. The braking force output member includes a first braking force output portion 203a and a second braking force output portion 203b arranged opposite to each other in the radial direction of the force output member. As shown in FIG. 2D, along the rotational direction r, the first driving force output portion 180h, the first braking force output portion 203a, the second driving force output portion 180m, and the second braking force output portion 203b are arranged in sequence.

As shown in FIG. 2D, a dividing line x is drawn extending through the rotational axis M1 and between the first braking force output portion 203a and the second driving force output portion 180m as well as between the first driving force output portion 180h and the second braking force output portion 203b. In FIG. 2D, the dividing line x divides the force output member 203 into a first force output portion 2031 and a second force output portion 2032, where the first force output portion 2031 includes the first driving force output portion 180h and the first braking force output portion 203a, and the second force output portion 2032 includes the second driving force output portion 180m and the second braking force output portion 203b. The structures of the first driving force output portion 180h and the second driving force output portion 180m are the same, and the structures of the first braking force output portion 203a and the second braking force output portion 203b are the same. The engagement process of the driving force receiving member 4 with the first force output portion 2031 and the second force output portion 2032 is the same.

For ease of description, the following text will use the engagement process of the first force output portion 2031 with the driving force receiving member 4 as an example. Furthermore, the first driving force output portion 180h in the first force output portion 2031 is abbreviated as the driving force output portion/driving portion 180h, and the first braking force output portion 203a in the first force output portion 2031 is abbreviated as the braking portion 203a. Along the rotational direction r, the braking portion 203a is positioned downstream of the driving portion 180h. The driving portion 180h and the braking portion 203a can rotate in the same direction about the rotational axis M1, and the braking portion 203a can rotate together with the driving portion 180h. Before the process cartridge is installed in the device, the driving portion 180h and the braking portion 203a partially overlap.

The braking portion 203a includes the first braking engagement member 204 and the second braking engagement member 208. In the radial direction of the force output member 203, the first braking engagement member 204 is positioned radially outward from the second braking engagement member 208. As shown in FIG. 2E, the first braking engagement member 204 and the second braking engagement member 208 are engaged through a rotation-stopping recess 204c and a rotation-stopping protrusion 208c, so that the first braking engagement member 204 and the second braking engagement member 208 can rotate together about the axis M1.

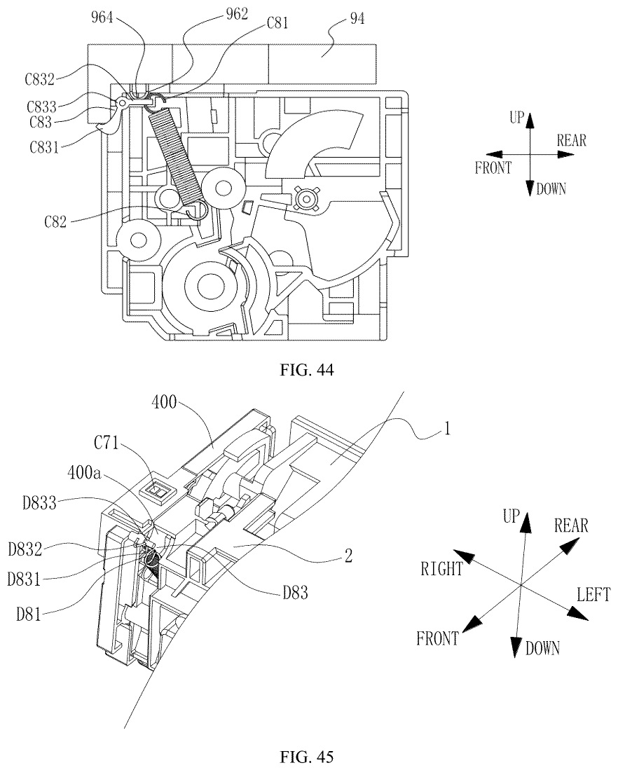

Furthermore, the force output member 203 further includes a first spring (drum drive coupling spring) 210 and a second spring (braking engagement spring) 211. The first spring 210 abuts against a braking transmission member 207, and the flange portion 207a of the braking transmission member 207 abuts against the second braking engagement member 208. At the same time, as shown in FIG. 2F (FIG. 44 of the referenced patent application), the protrusion 207f of the braking transmission member 207 also abuts against the contact surface 180f of the driving force output member. The second spring 211 abuts against the flange portion 204a of the first braking engagement member 204. Along the axis M1, the first braking engagement member 204, the second braking engagement member 208, and the driving portion 180h are configured to be able to retract and extend along the axis M1, that is, to move in the directions M1A and M1B shown in FIG. 21. Among them, the first braking engagement member 204 and the second braking engagement member 208 may either retract and extend along the axis M1 simultaneously, or in some imaging devices, they may retract and extend along the axis M1 separately. When the first braking engagement member 204 moves along the axis M1 in the direction M1A shown (toward the flange portion 180a) and after the rotation-stopping recess 204c and the rotation-stopping protrusion 208c disengage, the first braking engagement member 204 can rotate freely about the axis M1. When the second braking engagement member 208 moves along the axis M1 in the direction M1A shown, the first braking engagement member 204 will also move along the axis M1 in the direction M1A shown through the rotation-stopping recess 204c and the rotation-stopping protrusion 208c. Finally, both the first braking engagement member 204 and the second braking engagement member 208 can rotate freely about the axis M1.

Furthermore, as shown in FIG. 2H (FIG. 47 of the referenced patent application) and FIG. 2D, the second braking engagement member 208 further includes an inward protrusion 208e protruding radially inward from the coupling engagement portion 208b. In the direction M1B (as shown in FIG. 21) opposite to the direction M1A shown, the inward protrusion 208e is positioned at the free end of the second braking engagement member 208. As shown in FIGS. 2A-2D, the driving force output surface 180d is positioned on the driving portion 180h. Along the rotational direction of the force output member 203, the driving portion 180h is opposite to the first braking engagement member 204, that is, with a point through which the rotational axis M1 passes as the center, a circle is drawn in a plane perpendicular to the rotational axis M1, and this circle will pass through at least a portion of the driving portion 180h and at least a portion of the first braking engagement member 204.

Continuing to refer to FIGS. 2A-2D, the second braking engagement member 208 has an inward protrusion 208e protruding toward the rotational axis M1. Furthermore, along the rotational direction r of the force output member 203, the first braking engagement member 204 has an outer output surface 204g positioned downstream of the first braking engagement member body 204z, and the second braking engagement member 208 has an inner output surface 208f positioned downstream of the second braking engagement member body 208z. The inward protrusion 208e protrudes radially inward/toward the rotational axis M1 from the second braking engagement member body 208z. Along the rotational direction r, the inward protrusion 208e has a plane 208g positioned downstream, and the plane 208g is adjacent to the inner output surface 208f. Furthermore, as shown in FIG. 2B, along the direction of the rotational axis M1, the driving portion 180h has a driving end face 180y positioned at its end, the first braking engagement member 204 has a first braking end face 204y positioned at its end, and the second braking engagement member 208 has a second braking end face 208y positioned at its end. The end refers to the end of the driving portion 180h, the first braking engagement member 204, and the second braking engagement member 208 that is farthest from the flange portion 180a.

When the driving portion 180h and the braking portion 203a approach each other, the driving portion 180h and the braking portion 203a do not closely abut against each other. As shown in FIG. 2D, along the rotational direction r, a gap is formed between the first braking end face 204y and the driving portion 180h, and the minimum value of this gap is s, that is, the closest distance between the first braking end face 204y and the driving portion 180h is s.

As shown in FIG. 2C, the number of the driving portion 180h is two, and the two driving portions are arranged oppositely in the radial direction of the driving force output member 180. The driving force output member 180 further includes a connecting member 180k connecting the two driving portions. The connecting member 180k includes an intermediate member 183, and a first connecting member 181 and a second connecting member 182 positioned on the two radial sides of the intermediate plate 183, respectively. The below-mentioned positioning pedestal 180i protrudes from the intermediate plate 183 along the direction of the rotational axis M1. The structures of the first connecting member 181 and the second connecting member 182 are the same, and each is connected to one driving portion.

Furthermore, the driving portion 180h has a lower protrusion 180g on its side surface (driving force output surface) 180d facing the first braking engagement member 204. Along the rotational direction r, the driving portion 180h further includes an inclined surface 180j adjacent to the driving force output surface 180d. The first braking engagement member 204 has an upper protrusion 204f on its side surface facing the driving portion 180h. Before the process cartridge 100 is installed, the driving portion 180h and the first braking engagement member 204 approach each other along the rotational direction r, and along the direction of the rotational axis M1, the upper protrusion 204f and the lower protrusion 180g are opposite/overlap each other.

Overall, the lower protrusion 180g is integrally formed with the first connecting member 181, and the driving force output surface 180d protrudes from the lower protrusion 180g along the direction of the rotational axis M1. Along the rotational direction r, the lower protrusion 180g may also be viewed as protruding from the first connecting member 181/driving force output surface 180d, and the end of the lower protrusion 180g forms a front surface 180g1 that can follow the rotation of the driving portion 180h. Furthermore, along the rotational direction r, the first connecting member 181 further includes a sub-front surface 180g2 positioned downstream in the rotational direction, and the front surface 180g1 is connected to the sub-front surface 180g2, with both the front surface 180g1 and the sub-front surface 180g2 positioned at the downstream end of the first connecting member 181. Therefore, the front surface 180g1 and the sub-front surface 180g2 may be collectively designated as the downstream end face of the first connecting member 181.

Along the rotational direction r, the force output member 203 has a first space K1, a second space K2, and a third space K3, where the first space K1 refers to the space between the front surface 180g1 and the braking portion 203a, the second space K2 refers to the space between the braking portion 203a and the driving portion 180h positioned downstream of that braking portion. Specifically, as shown in FIG. 2D, the second space K2 refers to the space between the first braking force output portion 203a and the second driving force output portion 180m, or the space between the second braking force output portion 203b and the first driving force output portion 180h. The third space K3 refers to the space between the driving portion 180h/driving force output surface 180d and the first braking engagement member 204. When the driving portion 180h and the braking portion 203a partially overlap, as shown in FIG. 2D, along the rotational direction r, the second space K2 is larger than the first space K1/third space K3.

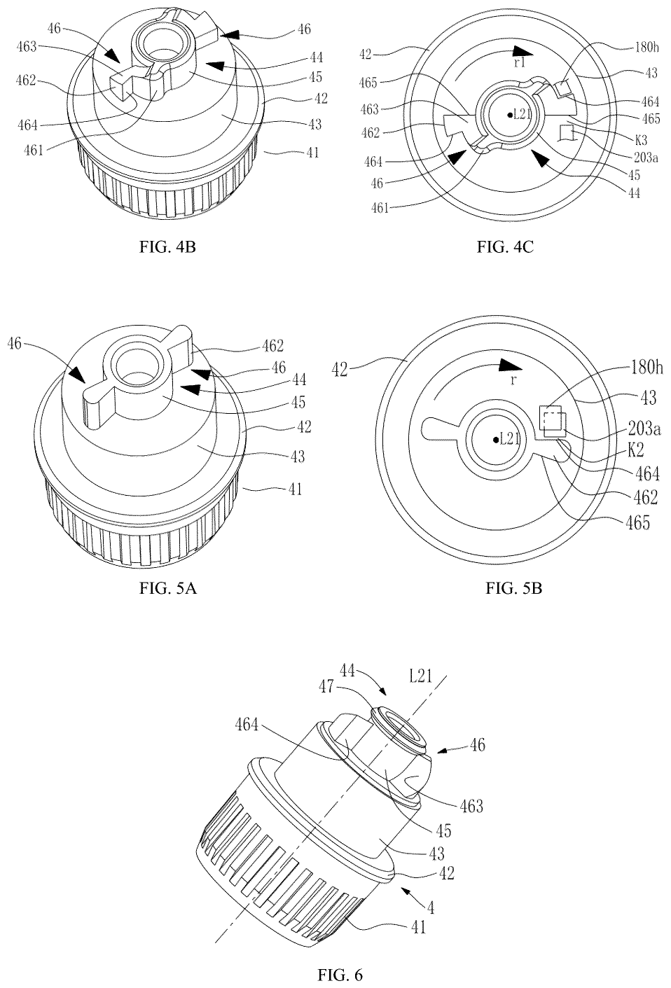

As shown in FIG. 4A, the driving force receiving member 4 according to the present application has a rotational axis L21 and includes a connecting portion 41, a chassis 42, a base 43, and an engagement portion 44. Along the direction of the rotational axis L21, the connecting portion 41, the chassis 42, the base 43, and the engagement portion 44 are arranged in sequence. The connecting portion 41 engages directly or indirectly with the rotating member to transmit driving force to the rotating member to drive the rotating member to rotate. The chassis 42 abuts against the rotating member so that the driving force receiving member 4 is positioned relative to the rotating member. The base 43 extends from the chassis 42, and the base 43 and the connecting portion 41 are positioned on two sides of the chassis 42 respectively. The engagement portion 44 extends from the base 43 in a direction away from the chassis 42. As a simplified structure, the chassis 42 may be omitted, and the base 43 may extend directly from the connecting portion 41. In a more simplified form, the base 43 may also be omitted, and the engagement portion 44 may extend from the connecting portion 41.

The structure of the engagement portion 44 will be described below, and other structures of the driving force receiving member 4 are not limited herein. To more clearly show the structure of the driving force receiving member according to the present application, only the driving force receiving member 4 is shown hereinafter. However, it should be understood that the driving force receiving member 4 is applicable to various rotating members in the process cartridge. According to actual product requirements, those skilled in the art may also combine the embodiments described below and their modified embodiments.

### Driving Force Receiving Member

### Embodiment 1

FIG. 4A is a perspective view of a photosensitive drum with the driving force receiving member according to Embodiment 1 of the present application; FIG. 4B is a perspective view of a first type of driving force receiving member according to Embodiment 1 of the present application; FIG. 4C is a side view when viewed along the direction of the rotational axis of the first type of driving force receiving member according to Embodiment 1 of the present application.

The photosensitive drum 21 has a rotational axis L21. The driving force receiving member 4 includes a connecting portion 41 (as shown in FIG. 4B), a chassis 42, a base 43, and an engagement portion 44. The connecting portion 42 connects the driving force receiving member 4 with the photosensitive drum 21 by embedding into the interior of the photosensitive drum 21. The chassis 42 abuts against the photosensitive drum 21 so that the driving force receiving member 4 is positioned relative to the photosensitive drum 21. The base 43 extends from the chassis 42, and the engagement portion 44 extends from the base 43 in a direction away from the chassis 42. As a simplified structure, the chassis 42 may be omitted, and the base 43 may extend directly from the connecting portion 41. In a more simplified form, the base 43 may also be omitted, and the engagement portion 44 may extend from the connecting portion 41.

The structure of the engagement portion 44 will be described below, and other structures of the driving force receiving member 4 are not limited herein.

The engagement portion 44 includes a central column 45 and a driving force receiving portion 46 extending radially outward from the central column 45. The rotational axis L21 passes through the central column 45, and two driving force receiving portions 46 are radially arranged opposite to each other around the central column 45. As shown in FIGS. 4A and 4B, each driving force receiving portion 46 includes a base portion 461 connected to the central column 45 and a protrusion 462 positioned radially outward from the base portion 461. In the radial direction of the driving force receiving member 4, the protrusion 462 is positioned radially outward from the base portion 461. A guide surface 463 extends from the base portion 461 towards the protrusion 462. The protrusion 462 has a first surface/driving surface 464 and a second surface/braking surface 465 adjacent to the guide surface 463, and both the first surface 464 and the second surface 465 are parallel to the rotational axis L21.

As the process cartridge C is being installed into the device, the guide surface 463 guides the braking portion 203a to move relative to the driving portion 180h, causing the driving force receiving portion 46 to reach between the driving portion 180h and the braking portion 203a, that is, the driving force receiving portion 46 enters the third space K3. As shown in FIG. 4C, the driving force output surface 180d abuts against the first surface 464, and the second surface 465 is spaced apart from the braking portion 203a. When the driving portion 180h rotates along the rotational direction r, the driving force is transmitted to the engagement portion 44 through the first surface 464, and thus the photosensitive drum 21 is driven to rotate about the rotational axis L21.

Since the second surface 465 is spaced apart from the braking portion 203a, that is, the driving force receiving member 4 does not need to be braked when it stops working, during the process of the process cartridge C returning from the working state to the non-working state or the photosensitive drum 21 returning from the rotating state to the non-rotating state, along the circumferential direction of the photosensitive drum 21, the braking portion 203a does not apply an action force/braking force to the driving force receiving member 4, which is equivalent to the braking portion 203a being shielded. This is beneficial for reducing wear of the driving force receiving member 4 during operation. Furthermore, after adopting the driving force receiving member 4 according to this embodiment, the braking portion 203a in the device no longer needs to return to a position where it is close to or partially overlapping with the driving portion 180h, which is beneficial for simplifying the structure of the device. For the driving portion 180h and the braking portion 203a that are already in a separated state, the driving force receiving member 4 of the next process cartridge does not need to be provided with a guide surface 463, and the structure of the process cartridge C can also be simplified.

### Embodiment 2

FIG. 5A is a perspective view of the driving force receiving member according to Embodiment 2 of the present application; FIG. 5B is a side view when viewed along the direction of the rotational axis of the driving force receiving member according to Embodiment 2 of the present application.

To facilitate understanding, structures that are the same as those of the first type of driving force receiving member 4 described above will use the same reference numerals.

The structure of the driving force receiving portion 46 in this embodiment differs from that in Embodiment 1. As shown in FIG. 5A, in this embodiment, the driving force receiving portion 46 is simplified to at least one independent protrusion 462. The protrusion 462 also includes opposite first surface 464 and second surface 465. Along the rotational direction r, the first surface 464 is positioned upstream of the second surface 465. When the process cartridge C is installed to the predetermined position in the device, the first surface 464 reaches the downstream space K2 (second space K2) of the braking portion 203a. At this time, the first surface 464 is opposite to the braking portion 203a.

When the process cartridge C begins to operate, the braking portion 203a rotates together with the driving portion 180h. At this time, the braking portion 203a abuts against the first surface 464 and drives the driving force receiving member 4 to rotate along the rotational direction r. Like Embodiment 1, the driving force receiving member 4 in this embodiment also does not need to be braked by the braking portion when it stops working, which is beneficial for reducing wear of the driving force receiving member 4 during operation. During the process of the process cartridge C returning from the working state to the non-working state or the photosensitive drum 21 returning from the rotating state to the non-rotating state, along the circumferential direction of the photosensitive drum 21, the driving portion 180h does not apply an action force/braking force to the driving force receiving member, which is equivalent to the driving portion 180h being shielded.

The structure of the driving force receiving member 4 in this embodiment is simplified, and at the same time, the contact surface between the driving force receiving portion 46 and the force output member 203 is increased, enhancing the stability of the engagement between the driving force receiving portion 46 and the force output member 203 and the force stability of the driving force receiving portion 46. The driving force receiving portion 46 and the force output member 203 are not easily disengaged.

On the other hand, since the second space K2 is the largest, compared to the driving force receiving portion 46 entering the first space K1 or the third space K3, the driving force receiving portion 46 more easily enters the second space K2. Therefore, adopting the solution of the braking portion 203a driving the driving force receiving member 4 can also improve the engagement efficiency of the driving force receiving member 4 with the force output member 203, preventing misalignment in the engagement between the driving force receiving member 4 and the force output member 203.

### Embodiment 3

FIG. 6 is a perspective view of the driving force receiving member according to Embodiment 3 of the present application.

In this embodiment, the above-mentioned braking surface 465 is eliminated. As shown, the driving force receiving portion 46 is only provided with a driving surface 464 and a guide surface 463. The guide surface 463 spirally extends upward from the base 43. After the process cartridge C with this driving force receiving portion 46/driving force receiving member 4 is installed in the imaging device, the guide surface 463 may also face the coupling engagement portion 204b/208b of the braking portion 203a and serve the same function as the braking surface 465. Therefore, the structure of the driving force receiving portion 46 is simplified, which is beneficial for improving the production efficiency of the driving force receiving portion 46 and the driving force receiving member 4 having this driving force receiving portion 46.

Furthermore, the driving force receiving portion 46 further includes a flange portion 47. The flange portion 47 is disposed along the outer circumference of the central column 45, or in other words, the flange portion 47 is formed by protruding radially outward from the outer circumferential surface of the central column 45. Preferably, along the direction of the rotational axis L21, the flange portion 47 is positioned at the free end 451 (the end away from the connecting portion 41) of the central column 45. When viewed along a direction perpendicular to the rotational axis L21, the driving force receiving portion 46 does not overlap with the flange portion 47. In the radial direction of the driving force receiving member 4, the protrusion dimension of the flange portion 47 does not exceed the dimension of the base portion 461/driving surface 464/guide surface 463. During the engagement process of the driving force receiving member 4 having this structure with the force output member 203, the coupling engagement portion 204b/208b of the braking portion 203a hooks onto the flange portion 47, thereby achieving engagement between the driving force receiving member 4 and the force output member 203. This can effectively prevent the driving surface 464 of the driving force receiving member 4 from disengaging from the driving force output surface 180d of the force output member 203, thus ensuring that the driving force receiving member 4 can stably receive driving force from the force output member.

### Embodiment 4

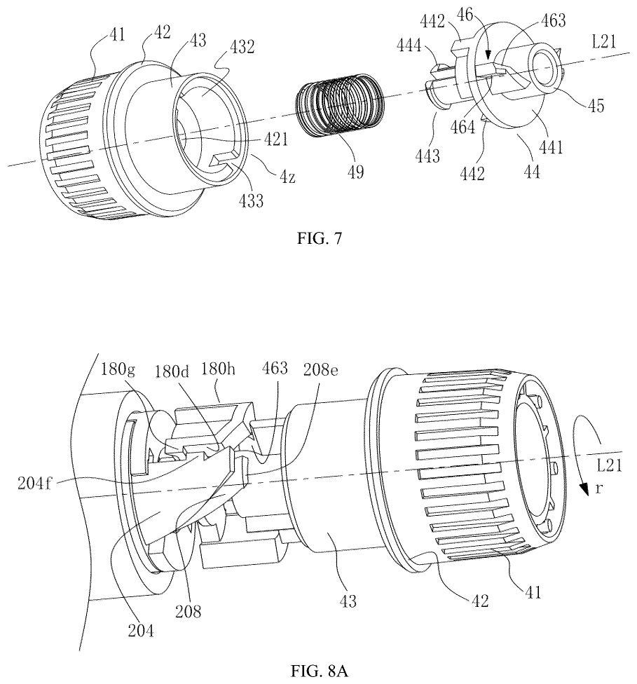

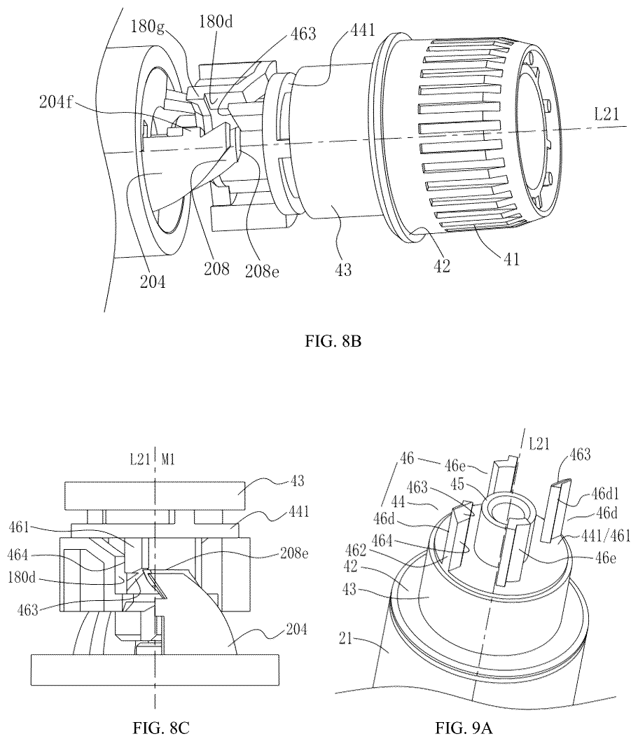

FIG. 7 is an exploded schematic view of the driving force receiving member according to Embodiment 4 of the present application; FIG. 8A is a perspective view of the driving force receiving member according to Embodiment 4 of the present application beginning to engage with the force output member; FIG. 8B is a perspective view of the driving force receiving member according to Embodiment 4 of the present application after engaging with the force output member; FIG. 8C is a side view when viewed in a direction perpendicular to the rotational axis of the driving force receiving member according to Embodiment 4 of the present application after engaging with the force output member.

In this embodiment, the engagement portion 44 is movably disposed along the direction of the rotational axis L21 relative to the second rotating member/photosensitive drum 21 or the connecting portion 41, that is, the engagement portion 44 can move between a position close to the connecting portion 41 (engagement portion retracted state) and a position away from the connecting portion 41 (engagement portion extended state).

As shown, the engagement portion 44 and the base 43 are formed separately. The driving force receiving member 4 further includes a movable cavity 432 formed in the interior of the base 43 and a holding member 49 for holding the engagement portion 44 in a position away from the second rotating member/photosensitive drum 21 or the connecting portion 41. The holding member 49 is preferably configured as a compression spring. At this time, the driving force receiving member 4 may be disassembled into an engaged portion 4z including the connecting portion 41, the chassis 42, and the base 43, an engagement portion 44 formed separately from the engaged portion 4z, and a holding member 49 positioned between the engaged portion and the engagement portion. The engaged portion 4z is configured to transmit the driving force received by the engagement portion 44, and the holding member 49 is configured to urge the engagement portion 44 in a direction away from the engaged portion 4z along the direction of the rotational axis L21. The engagement portion 44 includes a bottom plate 441, a central column 45 and a driving force receiving portion 46 extending from one side of the bottom plate 441, and a driving force transmission portion 442 extending from the other side of the bottom plate 441. Along the direction of the rotational axis L21, the central column 45 and the driving force receiving portion 46 extend in a direction away from the connecting portion 41, and the driving force transmission portion 442 extends in a direction close to the connecting portion 41.

The driving force receiving portion 46 is still provided with a guide surface 463 and a driving surface 464, where, during the engagement process of the driving force receiving member 4 and the force output member 203, the guide surface 463 is configured to force the braking portion 203a to rotate relative to the driving portion 180h, causing the braking portion 203a and the driving portion 180h to separate from each other. The driving surface 464 is configured to receive driving force. The driving force receiving portion 46 in this embodiment does not have a braking surface for receiving braking force.

The driving force transmission portion 442 is configured to engage with the base 43 to transmit the driving force received by the driving force receiving portion 46 to the base 43, thereby driving the rotating member 21 connected to the connecting portion 41 to rotate. In some embodiments, the driving force transmission portion 442 is configured as a protrusion extending along the direction of the rotational axis L21 from the bottom plate 441 in a direction toward the connecting portion 41. Correspondingly, the side wall of the movable cavity 432 is provided with a groove 433 that can mate with the protrusion, or the positions of the protrusion and the groove may be interchanged. The chassis 42 is formed as the bottom wall of the movable cavity 432. One end of the compression spring 49 abuts against the chassis 42, and the other end abuts against the side surface of the bottom plate 441 facing the connecting portion 41.

Furthermore, the engagement portion 44 further includes a guide engagement column 443 disposed on the same side as the driving force transmission portion 442. Correspondingly, a guide hole 421 that mates with the guide engagement column 443 is disposed on the chassis 42. The guide engagement column 443 is configured as a cantilever that can elastically deform in a direction intersecting with the rotational axis L21. A snap-fit protrusion 444 is disposed at the end of the cantilever. During the installation process of the engagement portion 44, the guide engagement column 443 is squeezed and undergoes elastic deformation, and the snap-fit protrusion 444 engages with the guide hole 421, enabling stable engagement between the engagement portion 44 and the connecting portion 41/base 43. During the movement process of the engagement portion 44 along the direction of the rotational axis L21, the mating of the guide engagement column 443 with the guide hole 421 can ensure that the movement trajectory of the engagement portion 44 does not deviate.

When the driving force receiving member 4 engages with the force output member 203, the guide surface 463 forces the braking portion 203a to rotate along the rotational direction r and separate from the driving portion 180h. Subsequently, the driving surface 464 faces the driving force output surface 180d, the engagement of the driving force receiving member 4 with the force output member 203 is completed, and the driving force receiving member 4 can receive the driving force output by the driving portion 180h.

In this embodiment, while the braking portion 203a is being pushed and guided by the guide surface 463, it will also gradually retract towards the retracted state. When the driving surface 464 faces the driving force output surface 180d, the braking portion 203a may either be in a state where it is pressed by the guide surface 463 or in an extended state where it is no longer pressed by the guide surface 463. Regardless of the state of the braking portion 203a, it will not affect the output of driving force from the driving force output surface 180d to the driving surface 464. The braking portion 203a at this time will not apply braking force to the driving force receiving member 4 and may be considered as being shielded.

Different from the above embodiments, the engagement portion 44 in this embodiment is configured to be retractable. During the engagement process of the driving force receiving member 4 with the force output member 203, the braking portion 203a is pressed by the guide surface 463, and conversely, the guide surface 463 is also pressed by the braking portion 203a. The engagement portion 44 will retract in a direction towards the connecting portion 41/photosensitive drum 21, and the compression spring 49 will also undergo elastic deformation. In this way, the driving force receiving portion 46 will be urged towards the force output member 203 by the compression spring 49, that is, the driving force receiving portion 46 can follow the movement of the driving portion 180h/braking portion 203a. Finally, this can also enable the driving force receiving member 4 and the force output member 203 to maintain a stable and tight engagement.

### Embodiment 5

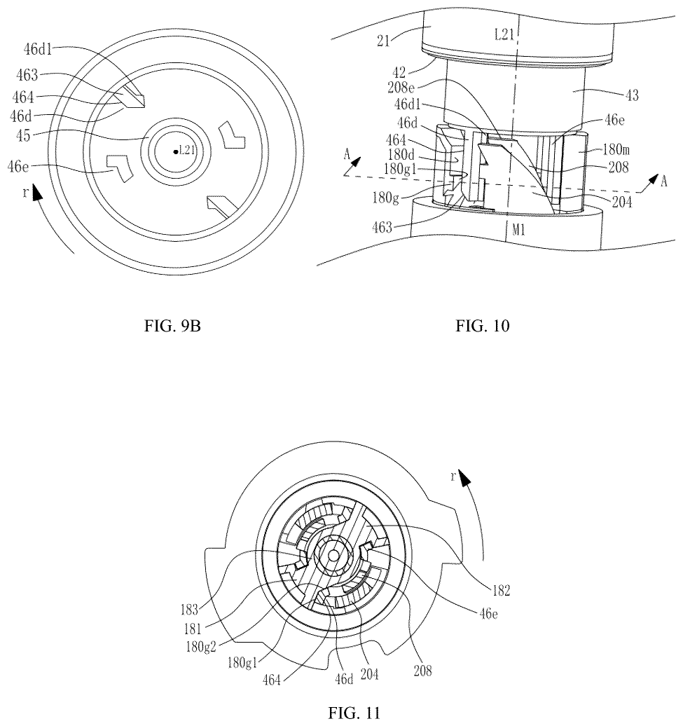

FIG. 9A is a perspective view of the driving force receiving member according to Embodiment 5 of the present application; FIG. 9B is a side view when viewed along the direction of the rotational axis of the driving force receiving member according to Embodiment 5 of the present application; FIG. 10 is a perspective view of the driving force receiving member according to Embodiment 5 of the present application after engaging with the force output member; FIG. 11 is a sectional view taken along the direction AA in FIG. 10 after the driving force receiving member according to Embodiment 5 of the present application engages with the force output member.

According to the structure of the force output member 203, the driving force receiving member 4 in this embodiment is configured so that when the driving force receiving member 4 engages with the force output member 203, the driving force receiving member 4 engages with the front surface 180g1 of the driving portion 180h.

As shown in FIGS. 9A and 9B, the driving force receiving portion 46 includes a base portion 461 and a protrusion 462 positioned radially outward from the central column 45. The protrusion 462 is further away from the rotational axis L21 than the base portion 461. The protrusion 462 forms a strip-shaped body extending along the direction of the rotational axis L21 and is still provided with a guide surface 463 and a driving surface 464, where the guide surface 463 is configured as an inclined surface that is inclined relative to the rotational axis L21 or a spiral surface. The driving surface 464 is disposed adjacent to the guide surface 463, and the driving surface 464 can match with the front surface 180g1.

As shown in FIG. 10, when the driving force receiving member 4 engages with the force output member 203, the guide surface 463 enters between the driving portion 180h/driving force output surface 180d and the braking portion 203a under the guiding action of the inclined surface 180j, and the driving surface 464 faces the front surface 180g1. As the force output member 203 rotates, driving force is transmitted to the driving surface 464 through the front surface 180g1. Preferably, the front surface 180g1 and the driving surface 464 are both configured to be parallel to the rotational axis L21/M1.

Furthermore, the driving force receiving portion 46 further includes a reinforcing portion 46e. Along the rotational direction r, the protrusion 462 and the reinforcing portion 46e are spaced apart. Among them, the protrusion 462 is configured to receive driving force and may be designated as a driven portion 46d. The reinforcing portion 46e is configured to enhance the strength of the driving force receiving member 4, preventing the driving force receiving member 4 from being broken during the process of receiving driving force, and also preventing the driving force receiving member 4 from being accidentally hit and broken by rolling before engaging with the force output member 203.

As shown in FIG. 11, when the driving force receiving member 4 engages with the force output member 203, the front surface 180g1 disposed on the first connecting member 181 abuts against the driven portion 46d, and the reinforcing portion 46e abuts against the second connecting member 182. This not only ensures stable engagement between the driven portion 46d and the front surface 180g1 but also serves the function of positioning the driven portion 46d.

In a modified form of this embodiment, continuing as shown in FIG. 11, the driving surface 464 may also be configured to receive driving force by abutting against the sub-front surface 180g2. Along the rotational direction r, the sub-front surface 180g2 is opposite to and separated from the first braking engagement member 204. When the driving surface 464 abuts against the sub-front surface 180g2, the protrusion 462 does not contact the first braking engagement member 204. It can be seen that in this modified form, the driving portion 180h can output driving force to the protrusion 462 without separating the driving portion 180h from the braking portion 203a.

### Embodiment 6

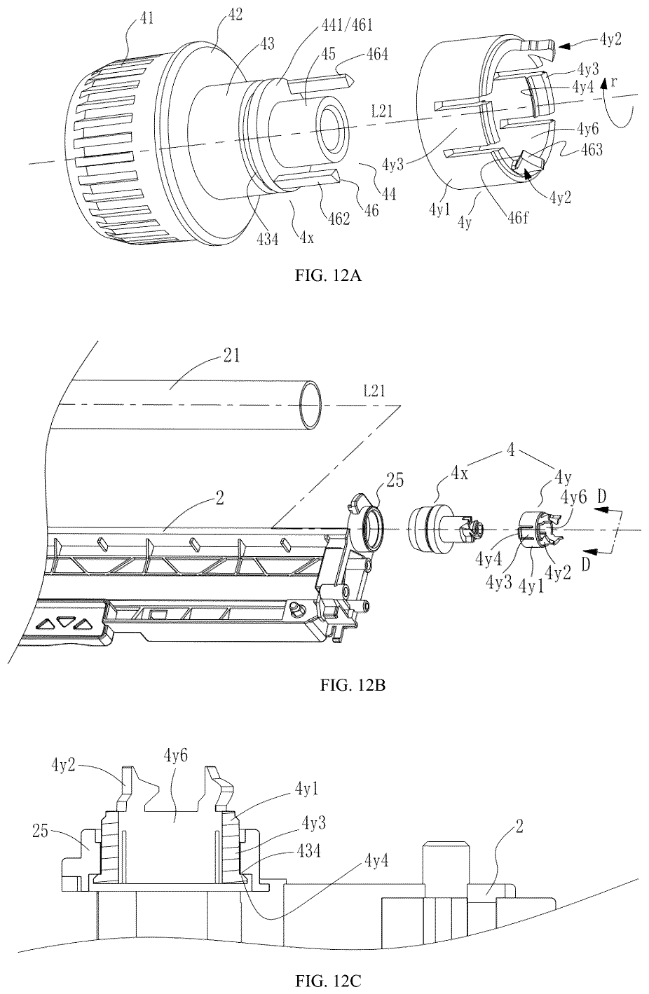

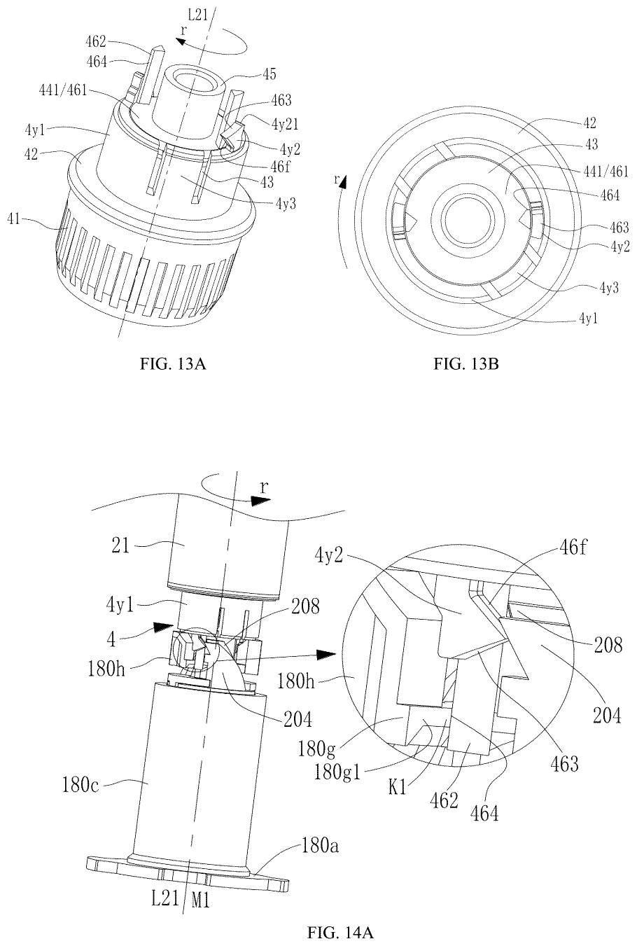

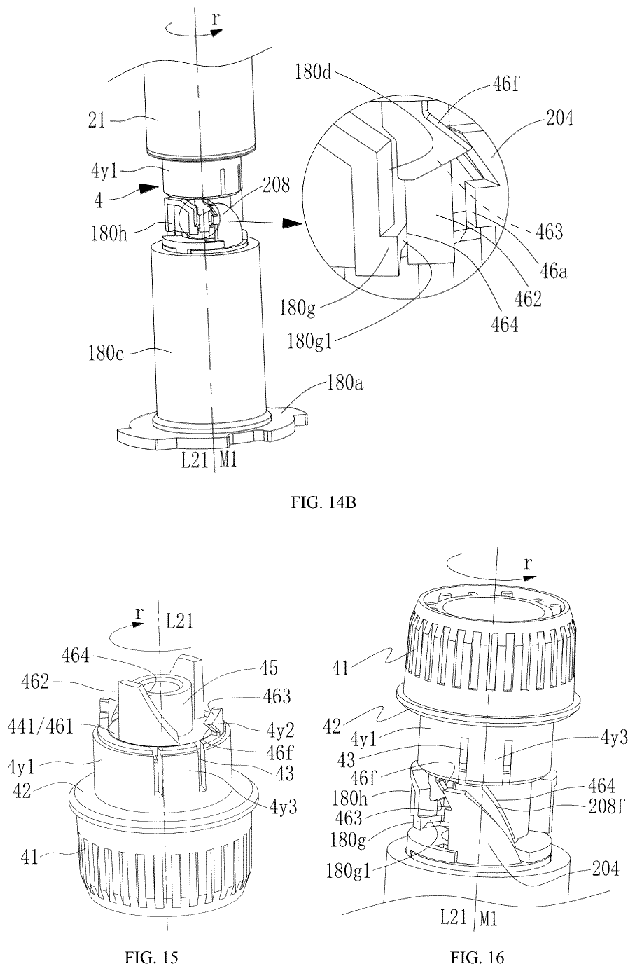

FIG. 12A is an exploded schematic view of the driving force receiving member according to Embodiment 6 of the present application; FIG. 12B is an exploded schematic view after the driving force receiving member in a modified embodiment of Embodiment 6 is separated from the second unit housing; FIG. 12C is a sectional view taken along the direction DD in FIG. 12B; FIG. 13A is a perspective view of the driving force receiving member according to Embodiment 6 of the present application; FIG. 13B is a side view when viewed along the direction of the rotational axis of the driving force receiving member according to Embodiment 6 of the present application; FIGS. 14A and 14B are views illustrating the state of the driving force receiving member according to Embodiment 6 of the present application after engaging with the force output member.

Similar to Embodiment 5, the driving force receiving member 4 in this embodiment is configured so that when the driving force receiving member 4 engages with the force output member 203, the driving force receiving member 4 engages with the front surface 180g1 of the driving portion 180h.

If the engagement method between the driving force receiving member 4 and the force output member 203 utilizes the above-mentioned embodiments where the braking portion 203a outputs driving force to the driving force receiving member 4, in actual tests, the imaging device will produce unacceptable noise. Preliminary analysis indicates that this noise is generated by the closely approaching driving portion 180h and braking portion 203a colliding with each other, or by the components of the force output member 203 touching the inner wall of the imaging device, or by the braking portion 203a retracting toward the interior of the cylindrical portion 180c.

For this purpose, this embodiment provides a driving force receiving member 4 that can eliminate the above noise. As shown in FIG. 12A, the driving force receiving member 4 includes a connecting portion 41, a chassis 42, a main body portion 4x, and an auxiliary member 4y. The main body portion 4x is connected to the connecting portion 41 or the chassis 42. The auxiliary member 4y is configured to be rotatable relative to the main body portion 4x/process cartridge housing/photosensitive drum 21. At least a portion of the auxiliary member 4y and the connecting portion 41 are positioned on two sides of the chassis 42 respectively. Specifically, the main body portion 4x includes a base 43 connected to the connecting portion 41 or the chassis 42 and an engagement portion 44 disposed on the base 43. The engagement portion 44 includes a central column 45 and a driving force receiving portion 46 extending radially outward from the central column 45. The rotational axis L21 passes through the central column 45. The driving force receiving portion 46 includes a base portion 461 and a protrusion 462. In the radial direction of the driving force receiving member 4/engagement portion 44, the protrusion 462 is positioned radially outward from the base portion 461. As mentioned above, the engagement portion 44 further includes a bottom plate 441. The central column 45 extends along the direction of the rotational axis L21 from one side of the bottom plate 441. The engagement portion 44 is connected to the base 43 through the bottom plate 441. In this embodiment, at least a portion of the bottom plate 441 may be considered as the base portion 461.

The protrusion 462 is configured as a columnar body extending along the direction of the rotational axis L21. A driving surface 464 for receiving driving force is disposed on the protrusion 462. Preferably, the main body portion 4x is integrally formed with the connecting portion 41 and the chassis 42, and the base 43 and the engagement portion 44 are also integrally formed. The protrusion 462 further includes a fourth surface 4621. Along the direction of the rotational axis L21, the fourth surface 4621 is the surface of the protrusion 462 that is farthest from the connecting portion 41. Along the direction of the rotational axis L21, when the protrusion 462 extends beyond the central column 45, the fourth surface 4621 becomes the end face 4w of the driving force receiving member 4. Preferably, the fourth surface 4621 is a plane. More preferably, the fourth surface 4621 is a plane perpendicular to the rotational axis L21.

The driving force receiving member 4 further includes a main body portion 4x provided with a driving force receiving portion 46, and at least a portion of the main body portion 4x is accommodated by the auxiliary member 4y. The auxiliary member 4y is provided with a limited portion 4y4, and the main body portion 4x is provided with a limiting portion 434 for engaging with the limited portion 4y4. Specifically, the auxiliary member 4y includes a carrier body 4y1, a separation member 4y2 protruding from the carrier body 4y1, and a limited portion 4y4 disposed on the carrier body 4y1 or the separation member 4y2. In some embodiments, the auxiliary member 4y/carrier body 4y1 is sleeved on the outside of the main body portion 4x. The main body portion 4x is also provided with a limiting portion 434 for engaging with the limited portion 4y4. Through the engagement of the limited portion 4y4 with the limiting portion 434, the auxiliary member 4y is limited along the direction of the rotational axis L21, but not limited along the rotational direction r. In some embodiments, the carrier body 4y1 is configured as a ring body forming an accommodation cavity 4y6 inside. At least a portion of the main body portion 4x is accommodated in the accommodation cavity 4y6. The limited portion 4y4 is configured as a snap-fit protrusion protruding radially toward the accommodation cavity 4y6 from the ring body 4y1. The limiting portion 434 is a snap-fit groove disposed on the outer surface of the base 43 or the engagement portion 44. The snap-fit groove 434 extends along the rotational direction r. Conversely, the snap-fit groove may also be disposed on the ring body 4y1, and the snap-fit protrusion 4y4 may be disposed on the base 43 or the engagement portion 44. The snap-fit protrusion may either extend a full circle along the rotational direction r or extend only a predetermined angle along the rotational direction r.

In some embodiments, to facilitate the engagement of the snap-fit protrusion 4y4 with the snap-fit groove 434, the auxiliary member 4y is also provided with an elastic arm 4y3 connected to the ring body 4y1. The snap-fit protrusion 4y4/snap-fit groove 434 is disposed on the elastic arm 4y3. By utilizing the elastic arm 4y3 that can elastically deform relative to the ring body 4y1, convenient engagement between the auxiliary member 4y and the main body portion 4x is achieved. Preferably, the elastic arm 4y3 is integrally formed with the main body portion 4y1. The elastic arm 4y3 and the main body portion 4y1 are made to enable the elastic arm 4y3 to elastically deform relative to the main body portion 4y1 by forming a gap therebetween. More preferably, in the case where the elastic arm 4y3 is provided, the snap-fit portion 4y4/snap-fit engaged portion 434 is only disposed on the elastic arm 4y3, which is more conducive to convenient engagement between the auxiliary member 4y and the main body portion 4x.

In some embodiments, the auxiliary member 4y may also be sleeved on the housing of the process cartridge. Similarly, the limited portion 4y4 may be disposed on the auxiliary member 4y, and a limiting portion for limiting the limited portion 4y4 may be disposed on the housing. As long as it is ensured that the auxiliary member 4y can rotate around a direction parallel to the rotational axis L21 and that the auxiliary member 4y will not separate from the housing, it is sufficient. For example, the limitation of the auxiliary member 4y may be achieved by the method of the housing abutting against the end face of the auxiliary member 4y. Based on this inventive concept, the auxiliary member 4y has multiple installation positions. For example, the auxiliary member 4y may be sleeved on at least one of the charging member, supply member, and agitating member.

Specifically, as shown in FIGS. 12B and 12C, the main body portion 4y1 is still provided with an elastic arm 4y3. The elastic arm 4y3 has a snap-fit portion 4y4. The housing/second unit housing 2 includes a support member 25 and a limiting portion 434 disposed in the support member 25. As shown, the auxiliary member 4y is rotatably supported by the support member 25. Along the direction of the rotational axis L21, the snap-fit portion 4y4 abuts against the limiting portion 434. Therefore, the auxiliary member 4y is limited in the direction of the rotational axis L21 but not limited in the rotational direction r. Furthermore, the auxiliary member 4y is sleeved on the outside of the main body portion 4x, or in other words, the main body portion 4x enters the accommodation cavity 4y6, and the auxiliary member 4y can rotate around the main body portion 4x.

In some embodiments, the auxiliary member 4y may also be installed in a positioning groove preset in the housing or the main body portion 4x in a rotatable manner. In this structure, there is no need to separately dispose a component for supporting the auxiliary member 4y in the positioning groove. The positioning of the auxiliary member 4y may be achieved using the inner wall of the positioning groove. Based on this, the carrier body 4y1 may also be configured as a solid body, as long as the carrier body 4y1 can rotate relative to the housing/photosensitive drum 21.

Preferably, when the auxiliary member 4y is coaxially arranged with the main body portion 4x, in the radial direction of the driving force receiving member 4, the separation member 4y2 and the protrusion 462 are spaced apart, so that the auxiliary member 4y provided with the separation member 4y2 can rotate freely about the rotational axis L21.

Furthermore, the separation member 4y2 is provided with a guide surface 463 and a hook surface 46f. Along the direction of the rotational axis L21, the separation member 4y2 has a tip portion 4y22 that is farthest from the connecting portion 41. The guide surface 463 is configured to guide the separation member 4y2 to a predetermined position. The hook surface 46f is configured to be inclined relative to the rotational axis L21. The inclination direction of the hook surface 465 is such that, when viewed along a direction perpendicular to the rotational axis L21, the hook surface 46f faces the connecting portion 41. Therefore, the hook surface 46f can serve the function of preventing the braking portion 203a from moving toward the flange portion 180a, that is, the hook surface 46f can prevent the force output member 203 from separating from the driving force receiving member 4.

At least a portion of the auxiliary member 4y is configured to separate the driving portion 180h and the braking portion 203a in the rotational direction of the force output member 203. During the process of the driving force receiving member 4 moving toward the force output member 203, at least a portion of the auxiliary member 4y enters the space between the driving portion 180h and the braking portion 203a, the guide surface 463 abuts against the braking portion 203a, forcing the braking portion 203a to move away from the driving portion 180h along the rotational direction r. Subsequently, along the rotational direction r, the separation member 4y2 enters the third space K3 between the driving portion 180h and the braking portion 203a. The separation member 4y2 faces the driving force output surface 180d. At the same time, the protrusion 462 reaches downstream of the front surface 180g1, positioned in the first space K1. The front surface 180g1 faces the driving surface 464, and the driving force receiving portion 46 engages with the driving portion 180h.

When the force output member 203 begins to rotate, the driving force output by the driving portion 180h is transmitted to the driving force receiving member 4 through the abutment of the front surface 180g1 with the driving surface 464. The hook surface 46f engages with the braking portion 203a. Since the hook surface 46f is configured as an inclined surface as described above, the braking portion 203a is “hooked” by the hook surface 46f and will not move along the direction of the rotational axis L21 toward the flange portion 180a. This hook surface 46f may also be viewed as an embodiment of an anti-detachment portion.

The driving portion 180 and the braking portion 203a are separated by the separation member 4y2, or in other words, at least a portion of the separation member 4y2 enters the third space K3. The driving force receiving member 4 described in this embodiment eliminates the noise emitted by the imaging device when receiving the driving force output by the force output member 203. Based on this, as long as the separation member 4y2 can enter the third space K3, causing the driving portion 180h and the braking portion 203a to separate from each other along the rotational direction r, it is sufficient. At this time, the hook surface 46f does not need to be provided.

As described above, the separation member 4y2 in this embodiment is configured to become movable as it rotates with the carrier body 4y1 relative to the housing/photosensitive drum 21. Therefore, during the installation and removal process of the process cartridge C, the movable carrier body 4y1/separation member 4y2 increases the flexibility of installation and removal of the process cartridge C, and the risk of interference between the process cartridge C and the imaging device is reduced.

### Embodiment 7

FIG. 15 is a perspective view of the driving force receiving member according to Embodiment 7 of the present application; FIG. 16 is a view illustrating the state of the driving force receiving member according to Embodiment 7 of the present application after engaging with the force output member.

The difference between this embodiment and Embodiment 6 is that the driving force receiving member 4 in this embodiment does not abut against the front surface 180g1 to receive driving force but instead abuts against at least one of the outer output surface 204g and the inner output surface 208f of the braking portion 203a to receive driving force.

The protrusion 462 is provided with a driving surface 464 that can match with at least one of the outer output surface 204g and the inner output surface 208f. The outer output surface 204g and the inner output surface 208f both extend spirally relative to the rotational axis L21, with their extension direction opposite to the rotational direction r. As shown in FIG. 16, after the driving surface 464 engages with the inner output surface 208f, as the force output member 203 rotates along the rotational direction r, the driving surface 464 receives driving force from the first braking engagement member 204, but the protrusion 462 also applies a reaction force toward the flange portion 180a to the first braking engagement member 204. This reaction force causes the second braking engagement member 208 to have a tendency to move toward the flange portion 180a. Therefore, there is a risk of disengagement between the driving surface 464 and the inner output surface 208f.

However, when the hook surface 46f disposed in the separation member 4y2 engages with the braking portion 203a, the braking portion 203a has a tendency to be pulled in a direction away from the flange portion 180a or in a direction toward the connecting portion 41. The tendency of the braking portion 203a to move toward the flange portion 180a is prevented, thereby enabling stable engagement between the driving surface 464 and the inner output surface 208f.

As described above, in this embodiment, the driving surface 464 engages with the inner output surface 208f. However, in some embodiments, the driving surface 464 may also be configured to engage with the outer output surface 204g. For example, the auxiliary member 4y may be rotatably mounted in a receiving groove disposed in the base 43, and in the radial direction of the driving force receiving member 4, the receiving groove is positioned on the radially inner side of the protrusion 462. During the engagement process of the driving force receiving member 4 with the force output member 203, the separation member 4y2 enters between the driving portion 180h and the braking portion 203a, separating the driving portion 180h and the braking portion 203a along the rotational direction r, and the protrusion 462 reaches the second space K2. Overall, at least a portion of the auxiliary member 4y enters the space between the driving portion 180h and the braking portion 203a, and the driving force receiving portion 46 engages with the braking portion 203a.

### Embodiment 8

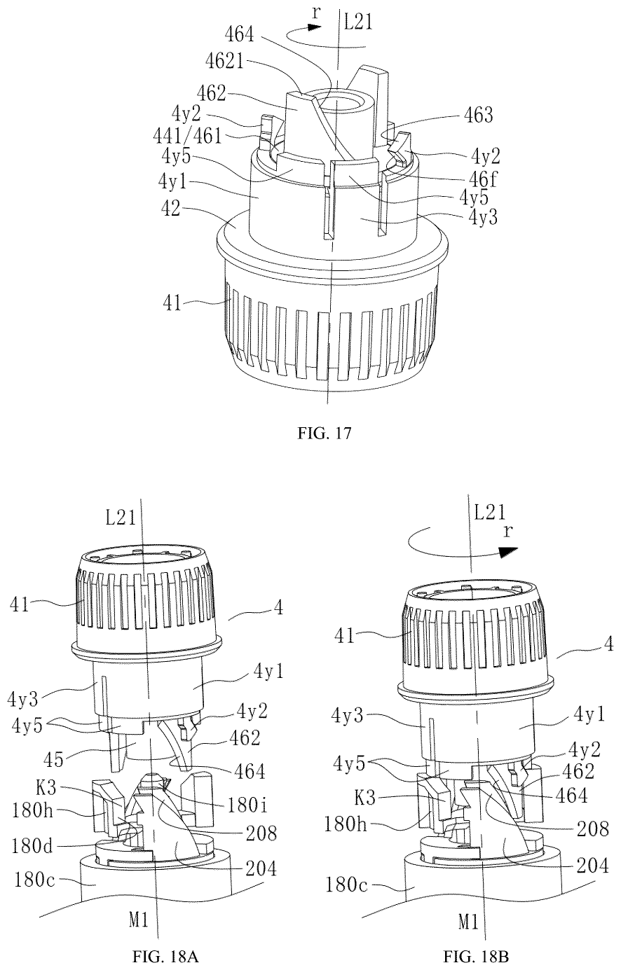

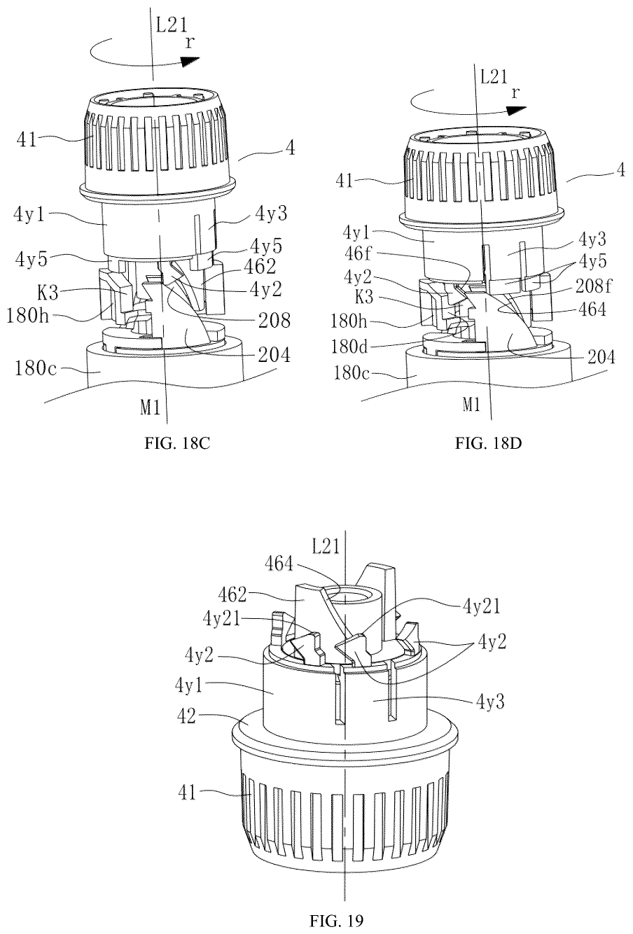

FIG. 17 is a perspective view of the driving force receiving member according to Embodiment 8 of the present application; FIGS. 18A-18D are schematic views of the engagement process of the driving force receiving member according to Embodiment 8 of the present application with the force output member.

Based on Embodiments 6 and 7, this embodiment further optimizes the structure of the auxiliary member 4y.

As described above, the auxiliary member 4y is configured to rotate freely about the rotational axis L21 relative to the main body portion 4x. Before the driving force receiving member 4 engages with the force output member 203, along the rotational direction r, the stopping position of the auxiliary member 4y relative to the main body portion 4x will be random, that is, the position of the separation member 4y2 relative to the main body portion 4x is uncertain.

To ensure that the separation member 4y2 can accurately enter between the driving portion 180h/driving force output surface 180d and the braking portion 203a (enter the third space K3), the driving force receiving member 4 in this embodiment adopts the following solution.

The auxiliary member 4y further includes at least one auxiliary protrusion 4y5 protruding from the ring body 4y1. The auxiliary protrusion 4y5 is configured to assist the separation member 4y2 and/or the driving surface 464 to reach a predetermined position. The predetermined position specifically is, along the rotational direction r, the separation member 4y2 enters the third space K3, and the protrusion 462 provided with the driving surface 464 enters the second space K2, with the driving surface 464 facing at least one of the outer output surface 204g and the inner output surface 208f. When multiple auxiliary protrusions 4y5 are provided, preferably, the auxiliary protrusions 4y5 are set as four, distributed at intervals along the circumferential direction of the auxiliary member 4y. More preferably, the four auxiliary protrusions 4y5 are distributed at equal intervals along the circumferential direction of the auxiliary member 4y.

As shown in FIG. 18A, when the driving force receiving member 4 approaches the force output member 203 along the direction of the rotational axis L21/M1, along the direction of the rotational axis L21/M1, the separation member 4y2 does not face the third space K3 but is offset to face the second space K2. As the driving force receiving member 4 continues to move, as shown in FIG. 18B, the auxiliary protrusion 4y5 abuts against the driving portion 180h and/or the braking portion 203a. When the process cartridge C reaches the installation position, the auxiliary protrusion 4y5 still abuts against the driving portion 180h and/or the braking portion 203a.

As shown in FIG. 18C, when the force output member 203 begins to rotate along the rotational direction r, the separation member 4y2 begins to abut against the downstream surface (outer output surface 204g and inner output surface 208f) of the braking portion 203a. As the force output member 203 continues to rotate, the braking portion 203a is pressed by the separation member 4y2 and moves toward the flange portion 180a (toward the interior of the cylindrical portion 180c) until the braking portion 203a passes over the tip portion 4y22 of the separation member 4y2. Subsequently, the braking portion 203a begins to abut against the guide surface 463. As shown in FIG. 18D, the separation member 4y2 enters the third space, and along the rotational direction r, the braking portion 203a gradually moves away from the driving portion 180h.

Similarly, during the process of the driving force receiving member 4 approaching the force output member 203, along the direction of the rotational axis L21/M1, regardless of whether the protrusion 462 directly faces the second space K2, or faces the downstream surface 204g/208f of the braking portion 203a, or faces the first braking end face 204y and/or the second braking end face 208y, or faces the driving portion 180h, as long as the force output member 203 begins to rotate along the rotational direction r, the protrusion 462 may either directly enter the second space K2 or enter the second space K2 by pressing the force output member 203. Eventually, the driving surface 464 can abut against the downstream surface of the braking portion 203a.

When the driving force receiving member 4 is configured so that the driving surface 464 abuts against the outer output surface 204g to receive driving force, in an extreme case, during the process of the driving force receiving member 4 approaching the force output member 203, along the direction of the rotational axis L21/M1, the protrusion 462 happens to face the third space K3. To prevent the protrusion 462 from entering the third space K3, it may be implemented that, along the rotational direction r, the minimum dimension of the fourth surface 4621 is greater than the distance s. When the extreme case occurs, the fourth surface 4621 can simultaneously abut against the driving end face 180y and the first braking end face 204y. As the force output member 203 rotates, the protrusion 462 can still enter the second space K2.

### Embodiment 9

FIG. 19 is a perspective view of the driving force receiving member according to Embodiment 9 of the present application.

Similar to the inventive concept of Embodiment 8, along the rotational direction r, the auxiliary member 4y is provided with multiple separation members 4y2 spaced apart from each other. During the process of the driving force receiving member 4 approaching the force output member 203 along the direction of the rotational axis L21/M1, along the direction of the rotational axis L21/M1, as long as any one of the multiple separation members 4y2 enters the third space K3, and after the protrusion 462 provided with the driving surface 464 enters the second space K2, the driving force receiving member 4 can smoothly receive the driving force output by the force output member 203, and the possible noise emitted by the imaging device is eliminated.

Like Embodiment 7, in this embodiment and Embodiment 8, when the driving force receiving member 4 fully engages with the force output member 203, the braking surface 465 engages with the braking portion 203a. Using the inclined surface structure possessed by the braking surface 465, the tendency of the braking portion 203a to move toward the flange portion 180a is prevented, and the driving surface 464 can stably receive driving force.

Among the multiple separation members 4y2, apart from the separation member 4y2 entering the third space K3, other separation members 4y2 may be viewed as the auxiliary protrusions 4y5 in Embodiment 8. Similarly, the separation members 4y2 equivalent to the auxiliary protrusions 4y5 may also be provided in multiple. Along the circumferential direction of the auxiliary member 4y, four auxiliary protrusions 4y5 are distributed at intervals. Preferably, the four auxiliary protrusions 4y5 are distributed at equal intervals along the circumferential direction of the auxiliary member 4y.

Furthermore, the separation members 4y2 may also be configured as five or six. The five or six separation members 4y2 are distributed at equal intervals along the circumferential direction of the auxiliary member 4y. When the number of separation members 4y2 is less than four, the separation members 4y2 may not be able to enter the third space K3, resulting in misalignment during engagement. When the number of separation members 4y2 is more than six, the separation members 4y2 may interfere with the force output member 203, preventing smooth engagement between the driving force receiving member 4 and the force output member 203.

### Embodiment 10

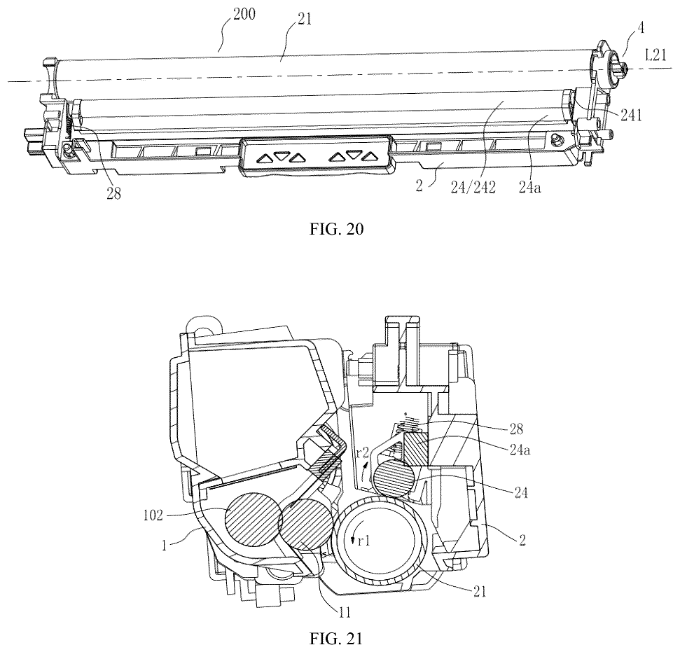

FIG. 20 is a perspective view of the second unit according to Embodiment 10 of the present application after hiding some components; FIG. 21 is a sectional view of a process cartridge having the second unit according to Embodiment 10 of the present application, taken along a plane perpendicular to the rotational axis of the photosensitive drum.

As described above, when the driving force receiving member 4 receives driving force, it will drive the photosensitive drum 21 to rotate in the direction r1 shown in FIG. 21. The charging member 24 in contact with the photosensitive drum 21 is driven by the friction force between the surface of the photosensitive drum 21 and the surface of the charging member 24 to rotate in the direction r2 shown.

Generally, for a charging member 24 that is configured to contact the photosensitive drum 21 for charging, the charging member 24 includes a metal shaft 241 and an elastic body/covering layer 242 covering the outer surface of the metal shaft. Obviously, the density of the metal shaft is greater than the density of the elastic body, and correspondingly, the inertia of the metal shaft is also greater than the inertia of the elastic body. When the photosensitive drum 21 stops rotating, the charging member 24 will lose its drive source, but under the action of inertia, the metal shaft will cause the charging member 24 to continue rotating. As a result, the friction force between the surface of the charging member 24 and the surface of the photosensitive drum 21 may also cause the photosensitive drum 21 to continue rotating.

In the prior art, by using the braking portion 203a disposed in the force output member 203 to apply braking force to the driving force receiving member 4 configured to drive the photosensitive drum 21 to rotate, the possible continued rotation of the photosensitive drum 21 can be prevented. However, the structure of the force output member 203 with the braking portion 203a becomes complex, which not only increases the manufacturing difficulty of the imaging device and the driving force receiving member 4 but also increases the control difficulty of the imaging device.

Based on the above embodiments, this embodiment provides a simple structure that can prevent the continued rotation of the photosensitive drum 21. As shown in FIGS. 20 and 21, the process cartridge C further includes a friction member 24a disposed adjacent to and in contact with the charging member 24. The friction member 24a extends along the direction of the rotational axis L21. When the charging member 24 loses its drive source, the friction member 24a forces the charging member 24, which continues to rotate due to inertia, to stop rotating by using the friction force between the friction member 24a and the charging member 24. Therefore, the risk of the photosensitive drum 21 continuing to rotate can be eliminated.

Commonly, the friction member 24a may be configured as a sponge body, a rubber body, or other elastic components. When the charging member 24 is driven to rotate by the photosensitive drum 21, the friction member 24a will not apply excessive friction force to the charging member 24, thereby not increasing the load on the charging member 24. However, when the charging member 24 is no longer driven by the photosensitive drum 21, the friction force between the friction member 24a and the charging member 24 is sufficient to force the charging member 24, which continues to rotate due to inertia, to stop rotating.

On the other hand, during the operation of the process cartridge C, the high-speed rotating photosensitive drum 21 causes the developer on its surface to leave the photosensitive drum 21 and reach the surface of the charging member 24 under the action of centrifugal force. The developer reaching the surface of the charging member 24 will reduce the charging efficiency of the charging member 24 to the photosensitive drum 21. The setting of the friction member 24a can also serve the function of cleaning the surface of the charging member 24. With the rotation of the charging member 24, the developer reaching the surface of the charging member 24 can be adsorbed or scraped by the friction member 24a. Therefore, the charging member 24 can efficiently charge the photosensitive drum 21.

### Embodiment 11

FIG. 22A is a perspective view of the driving force receiving member according to Embodiment 11 of the present application; FIG. 22B is a side view when viewed in a direction perpendicular to the rotational axis of the driving force receiving member according to Embodiment 11 of the present application.

Based on the inventive concept of the above embodiments, the structures of the separation member 4y2, the protrusion 462, and the flange portion 47 of the driving force receiving member 4 in this embodiment differ from those in the above embodiments. They will be described separately below.

In this embodiment, the protrusion 462 is provided with a driving surface 464 that can engage with the outer output surface 204g or the inner output surface 208f of the braking portion 203a. Preferably, the protrusion 462 is also provided with a sub-driving surface 464a adjacent to the driving surface 464. The sub-driving surface 464a is configured to abut against the plane 208g to receive the driving force of the plane 208g. Therefore, the driving surface 464 may also be designated as the main driving surface, and the sub-driving surface 464a may also be designated as the secondary driving surface.

The driving force receiving member 4 can receive driving force by abutting at least one of the main driving surface 464 and the secondary driving surface 464a against the braking portion 203a, thereby enabling the driving force receiving member 4 to stably receive driving force.

The separation member 4y2 includes a separation member body 4y21 and a tip portion 4y22 that are mutually engaged. The separation member body 4y21 is provided with the above-mentioned guide surface 463 and hook surface 46f. The tip portion 4y22 extends from the guide surface 463 in a direction further away from the carrier body 4y1. Preferably, the tip portion 4y22 is configured as a conical shape. Along the rotational direction r, the tip portion 4y22 is positioned upstream of the separation member 4y2. The guide surface 463 extends all the way from the separation member body 4y21 to the tip portion 4y22. Along the direction of the rotational axis L21, the further the tip portion 4y22 is from the carrier body 4y1, the smaller its volume. Thus, during the initial engagement of the driving force receiving member 4 with the force output member 203, the tip portion 4y22 can more quickly and accurately enter the third space K3.

During the engagement process of the driving force receiving member 4 with the force output member 203, a part of the flange portion 47 is configured to guide the braking portion 203a, ensuring that the braking portion 203a can always reach the upstream side of the main driving surface 464 and/or the secondary driving surface 464a. This part of the flange portion 47 may be viewed as an embodiment of a braking portion guide member. Specifically, the flange portion 47 is configured to extend radially outward from the outer surface of the central column 45. Preferably, two flange portions 47 are radially arranged opposite to each other on the outer surface of the central column 45. Along the rotational direction r, a guide groove 472 is formed between the two flange portions 47, and the face of the flange portion 47 facing the guide groove 472 forms a positioning guide surface 471. More preferably, along the rotational direction, the main driving surface 464/secondary driving surface 464a is positioned downstream of at least a portion of the guide groove 472/positioning guide surface 471. In some embodiments, the braking portion guide member 47 may not extend radially outward from the outer surface of the central column 45 but may be formed by the outer surface of the central column 45 radially recessing inward, as long as the guide groove 472 and/or the positioning guide surface 471 can be formed.

Preferably, as shown in FIG. 22B, when using the connecting portion 41 or the chassis 42 as a reference, along the direction of the rotational axis L21, the separation member 4y2 extends further than the protrusion 462, that is, along the direction of the rotational axis L21, the separation member 4y2 protrudes further than the main driving surface 464/secondary driving surface 464a. This way, during the approach of the driving force receiving member 4 and the force output member 203, the separation member 4y2 first enters the third space K3 to complete the separation of the driving portion 180h and the braking portion 203a, and then the main driving surface 464/secondary driving surface 464a abuts against the corresponding position of the braking portion 203a. This structure can effectively prevent the main driving surface 464/secondary driving surface 464a from first abutting against the corresponding position of the braking portion 203a, after which the separation member 4y2 cannot separate the driving portion 180h and the braking portion 203a, ultimately causing the imaging device to produce unacceptable noise during operation.

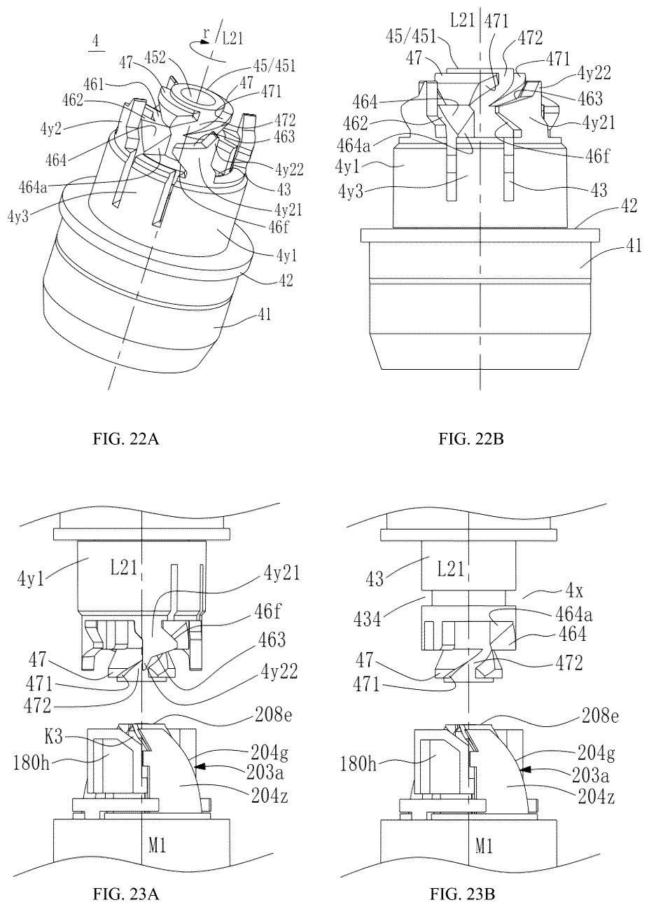

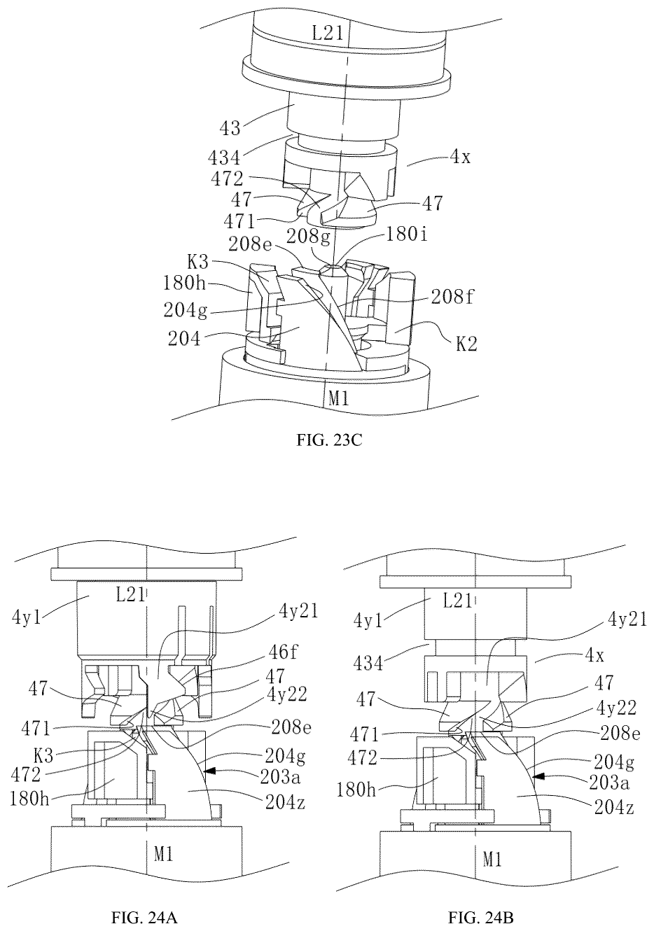

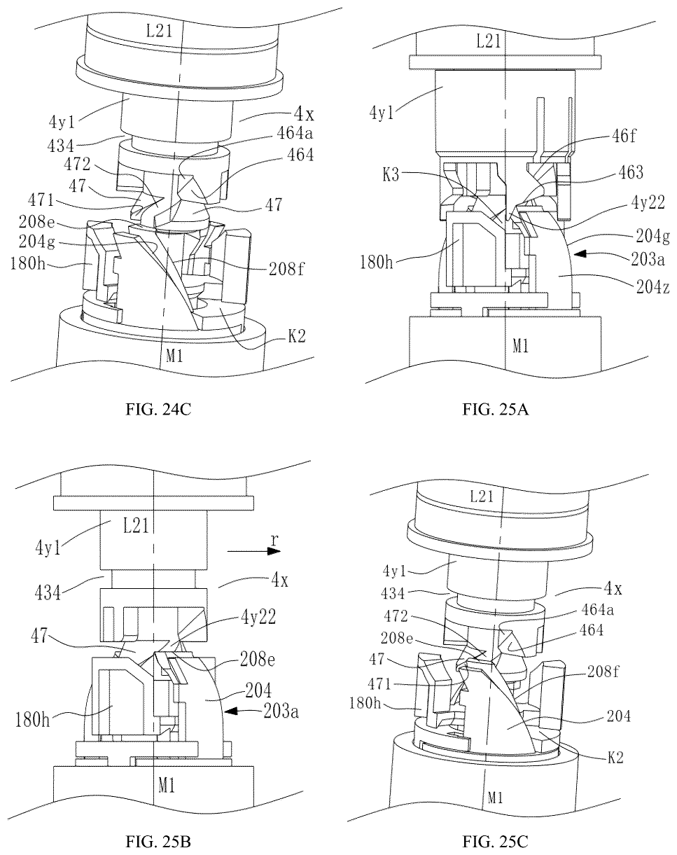

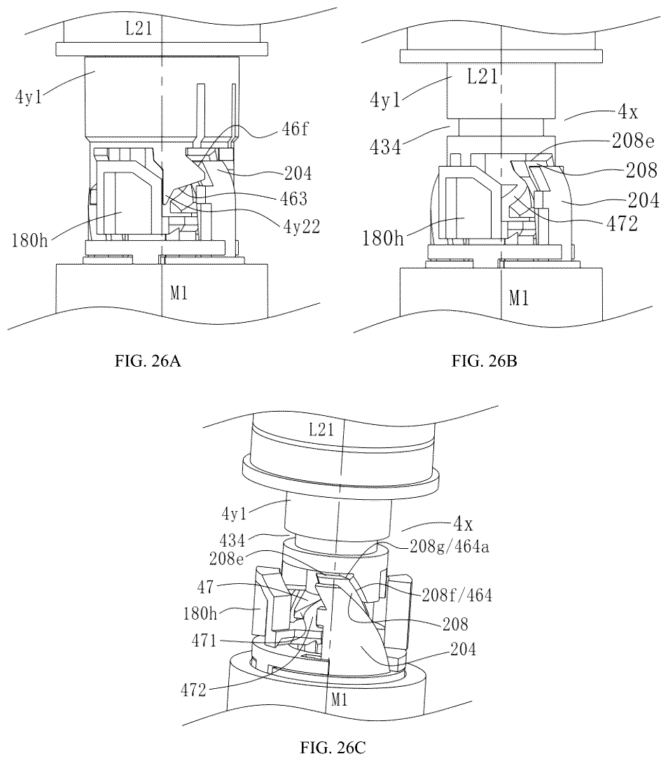

As shown in FIGS. 23A-26C, before the driving force receiving member 4 and the force output member 203 begin to engage, along the direction of the rotational axis L21, the tip portion 4y22 faces the third space K3, and the protrusion 462 faces the second space K2. As the driving force receiving member 4 and the force output member 203 gradually approach each other, the tip portion 4y22 begins to enter the third space K3. Subsequently, the braking portion 203a begins to be guided by the guide surface 463. Along the rotational direction r, the driving portion 180h and the braking portion 203a gradually separate from each other, and the outer output surface 204g and the inner output surface 208f gradually approach the main driving surface 464, while the plane 208g gradually approaches the secondary driving surface 464a. Finally, the separation member 4y2 enters the third space K3, the protrusion 462 enters the second space K2, and the driving force receiving member 4 and the force output member 203 complete their engagement.

Furthermore, as shown in FIGS. 23B, 23C, 24B, 24C, 25B, 25C, 26B, and 26C, during the initial engagement of the driving force receiving member 4 with the force output member 203, the inward protrusion 208e of the braking portion 203a enters the guide groove 472 and is guided by the positioning guide surface 471. Therefore, the relative position of the main body portion 4x of the driving force receiving member 4 and the force output member 203 is determined. It can be seen that the guide groove 472/positioning guide surface 471 serves the function of positioning the main driving surface 464 and/or the secondary driving surface 464a by guiding the inward protrusion 208e. Along the direction of the rotational axis L21, the closer the flange portion 47 is to the free end 451 of the central column, the earlier the inward protrusion 208e can be guided by the guide groove 472/positioning guide surface 471, thus making the engagement of the driving force receiving member 4 with the force output member 203 smoother.

Specifically, along the rotational direction r, since both the outer output surface 204g and the inner output surface 208f are positioned downstream of at least a portion of the inward protrusion 208e, and the main driving surface 464 and the secondary driving surface 464a are positioned downstream of at least a portion of the guide groove 472, when the inward protrusion 208e is guided by the guide groove 472/positioning guide surface 471, along the direction of the rotational axis L21, at least a portion of the main driving surface 464 and at least a portion of the secondary driving surface 464a will face the second space K2. Along the rotational direction r, the driving surface 464 and the secondary driving surface 464a will face the braking portion 203a. Thus, the driving force receiving member 4 and the force output member 203 can achieve smoother engagement.

Before the driving force receiving member 4 and the force output member 203 begin to engage, along the direction of the rotational axis L21, when the tip portion 4y22 does not face the third space K3, the relative position of the driving force receiving member 4 and the force output member 203 can be determined by the braking portion 203a through the inward protrusion 208e being guided by the guide groove 472/positioning guide surface 471, and thus the protrusion 462 provided with the main driving surface 464 and the secondary driving surface 464a can also face the second space K2. With the rotation of the force output member 203, the separation member 4y2 can also enter the third space K3 along with the tip portion 4y22. It can be seen that even without setting the auxiliary member 4y, as long as the guide groove 472/positioning guide surface 471 is provided, the engagement of the driving force receiving member 4 with the force output member 203 can be achieved. In a case where the possible unacceptable noise produced by the imaging device due to the driving portion 180h and the braking portion 203a approaching each other is not considered, the driving force receiving member 4 can still be driven by the force output member 203 to work.

In the case where the auxiliary member 4y is provided, when the guide groove 472/positioning guide surface 471 guides the inward protrusion 208e, causing the main driving surface 464 and the secondary driving surface 464a to face the braking portion 203a, but the tip portion 4y22 has not yet entered the third space K3, the position of the tip portion 4y22 has the following possibilities:

Along the direction of the rotational axis L21, the tip portion 4y22 faces the braking portion 203a. With the rotation of the force output member 203, after the tip portion 4y22 passes over the braking portion 203a, it enters the third space K3.

Along the direction of the rotational axis L21, the tip portion 4y22 faces the driving portion 180h. With the rotation of the force output member 203, the tip portion 4y22 first enters the second space K2, and then after passing over the braking portion 203a, it enters the third space K3.

### Embodiment 12

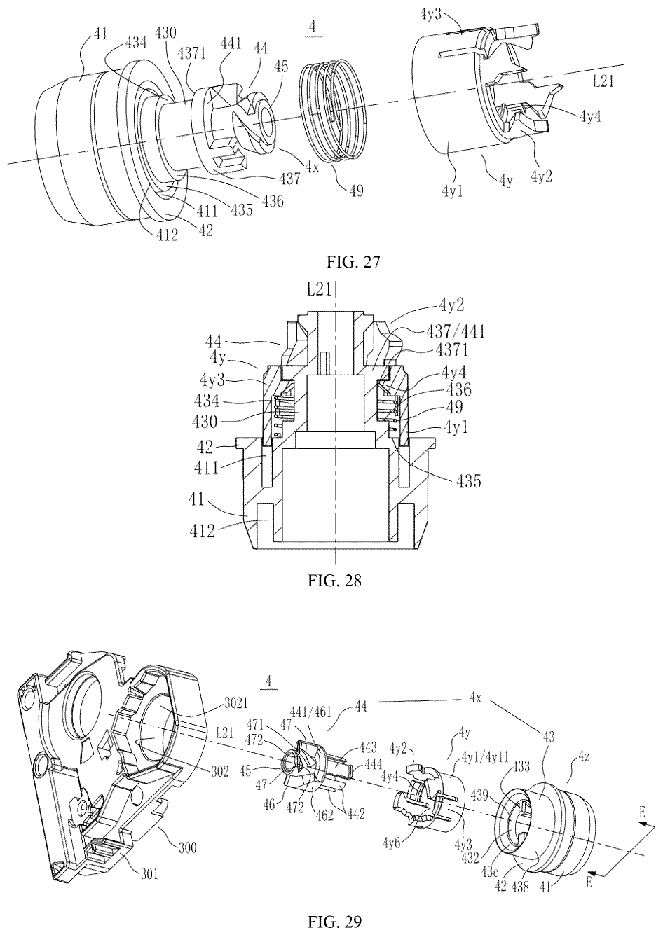

FIG. 27 is an exploded schematic view of components of the driving force receiving member according to Embodiment 12 of the present application; FIG. 28 is a sectional view of the driving force receiving member according to Embodiment 12 of the present application taken along a plane extending through its rotational axis.

As described above, during the engagement process of the driving force receiving member 4 with the force output member 203, when the separation member 4y2 cannot smoothly enter the third space K3, the separation member 4y2 will abut against the driving portion 180h and/or the braking portion 203a. To prevent the abutment of the separation member 4y2 with the driving portion 180h and/or the braking portion 203a from exceeding the maximum deformation amount of the first spring 210/second spring 211, thereby preventing the driving force receiving member 4 from smoothly engaging with the force output member 203, the auxiliary member 4y/separation member 4y2 in this embodiment is movably disposed along the direction of the rotational axis L21.

As shown, under the inventive concept of the above-described auxiliary member 4y, a compression spring 49 serving as a holding member is disposed between the auxiliary member 4y and the main body portion 4x. Specifically, the driving force receiving member 4 includes a base platform 412 disposed in the connecting portion 41, a first stepped surface 435 disposed on the base platform 412, an intermediate member 430 extending along the direction of the rotational axis L21 from the base platform 412, and an engagement portion 44 connected to the intermediate member 430. The base platform 412 forms part of the main body portion 4x, and an auxiliary member accommodation portion 411 capable of accommodating the auxiliary member 4y forms between the base platform 412 and the inner wall of the connecting portion 41. Specifically, in the radial direction of the driving force receiving member 4, the connecting portion 41 surrounds at least a portion of the base platform 412 on the outer side of the base platform 412, and the auxiliary member accommodation portion 411 is positioned between the connecting portion 41 and the base platform 412.

In the radial direction of the driving force receiving member 4, the diameter of the bottom plate 441 of the engagement portion is larger than the diameter of the intermediate member 430, and the diameter of at least a portion of the base platform 412 is larger than the diameter of the intermediate member 430. Thus, the limiting portion 434 is formed between the bottom plate 441 and the base platform 412. One end of the compression spring 49 abuts against the first stepped surface 435, and the other end abuts against the auxiliary member 4y/limited portion 4y4.

When the auxiliary member 4y/separation member 4y2 abuts against the driving portion 180h and/or the braking portion 203a, even if the first spring 210/second spring 211 has reached its maximum deformation amount, the auxiliary member 4y/separation member 4y2 can retract toward the connecting portion 41 by compressing the compression spring 49 to undergo elastic deformation. When the auxiliary member 4y/separation member 4y2 no longer abuts against the driving portion 180h and/or the braking portion 203a, the compression spring 49 releases its elastic force, and the auxiliary member 4y/separation member 4y2 extends in a direction away from the connecting portion 41.

Preferably, along the direction of the rotational axis L21, the driving force receiving member 4 further includes a second stepped surface 436 disposed further away from the connecting portion 41 than the first stepped surface 435. The bottom plate 441 forms part of the main body portion 4x, and thus the bottom plate 441 may also be viewed as an upper limiting plate 437 of the limiting portion 434. The component forming the second stepped surface 436 may be viewed as a lower limiting plate of the limiting portion 434. The limited portion 4y4 can move along the direction of the rotational axis L21 between the lower surface 4371 of the upper limiting plate 437 and the second stepped surface 436 of the lower limiting plate.

In some embodiments, the second stepped surface 436 may also be flush with the first stepped surface 435. In this way, the structure of the driving force receiving member 4 will become simpler, and both the compression spring 49 and the limited portion 4y4 can move between the lower surface 4371 of the upper limiting plate 437 and the second stepped surface 436 of the lower limiting plate.

According to the inventive concept of this embodiment, the compression spring 49 may also be replaced by an elastic arm, sponge, rubber, etc., or the compression spring 49 may be replaced by a tension spring to achieve the function of the above-mentioned holding member.

As described above, configuring the separation member 4y2 to be able to elastically move along the direction of the rotational axis L21 relative to the connecting portion 41/photosensitive drum can avoid the separation member 4y2 abutting the driving portion 180h and the braking portion 203a such that they cannot move along the direction of the rotational axis M1. This improves the flexibility of engagement between the driving force receiving member 4 and the force output member 203, effectively preventing interference between the driving force receiving member 4 and the force output member 203.

### Embodiment 13

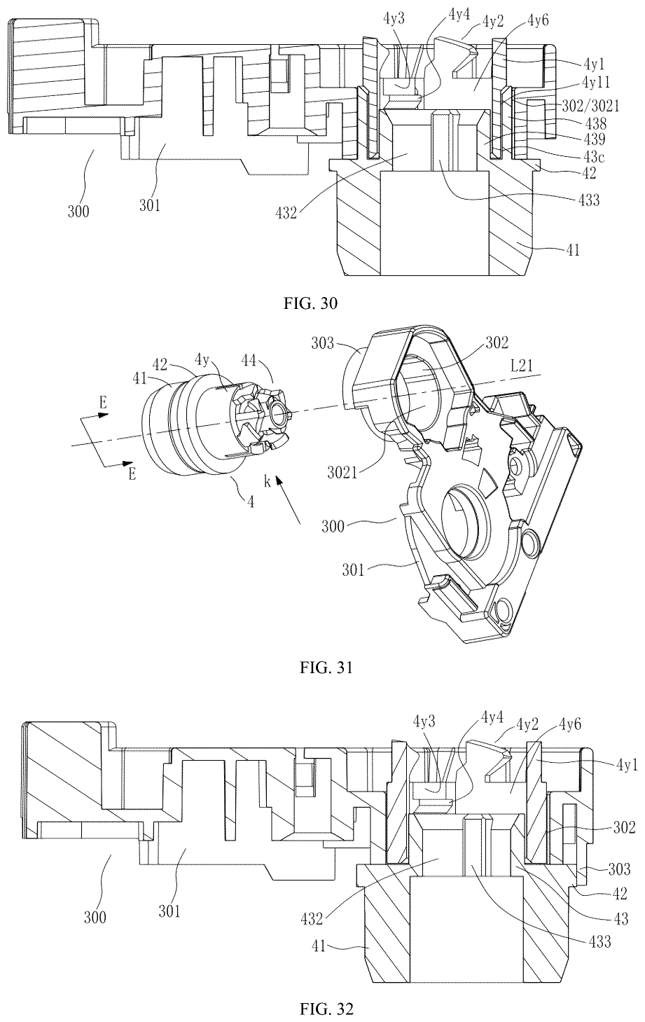

FIG. 29 is an exploded schematic view of the driving force receiving member after the driving force receiving member according to Embodiment 13 of the present application is separated from the drive end cover; FIG. 30 is a sectional view taken along the direction EE extending through the rotational axis of the driving force receiving member according to Embodiment 13 of the present application.

As shown in FIGS. 20 and 21, the charging member 24 is configured to charge the surface of the photosensitive drum 21, and the charging member 24 rotates by contacting the photosensitive drum 21, utilizing the friction force between the surface of the photosensitive drum 21 and the surface of the charging member 24. To ensure good contact between the photosensitive drum 21 and the charging member 24, the process cartridge further includes an elastic member 28 for applying a force to the charging member 24, causing the charging member 24 to approach the photosensitive drum 21. The elastic member 28 may be a compression spring applying a pushing force to the charging member 24, or it may be a tension spring applying a pulling force to the charging member 24. Under the action of the force applied by this elastic member 28, the surface of the charging member 24 maintains good contact with the surface of the photosensitive drum 21. The following description will use an example where the elastic member 28 is configured as a compression spring. When the elastic member 28 is configured as a tension spring, the structures according to this embodiment, as well as Embodiments 14 and 15, are also applicable.

It is understood that the elastic force applied to the charging member 24 by the elastic member 28 will be transmitted to the driving force receiving member 4, and the driving force receiving member 4 is exposed from the drive end cover 300. Under the action of this elastic force, the friction force between the base 43 of the driving force receiving member 4 and the drive end cover 300 will also increase. Especially in the above-described driving force receiving member 4 provided with the auxiliary member 4y, the auxiliary member 4y is positioned radially outward from the base 43. In other words, in the driving force receiving member 4 provided with the auxiliary member 4y, the friction force between the auxiliary member 4y and the drive end cover 300 and/or the friction force between the auxiliary member 4y and the engagement portion 44/main body portion 4x will increase. The auxiliary member 4y needs to be configured to rotate relative to the main body portion 4x/process cartridge housing/photosensitive drum 21, and the higher the rotational flexibility of the auxiliary member 4y, the smoother the engagement process of the driving force receiving member 4 with the force output member 203.

For this purpose, based on the above embodiments, one objective of this embodiment is to prevent an increase in the resistance when the auxiliary member 4y rotates, thereby maintaining the rotational flexibility of the auxiliary member 4y.

The driving force receiving member 4 includes an engaged portion 4z and an engagement portion 44 that are mutually engaged, and an auxiliary member 4y that is rotatable relative to the engagement portion 44. The driving force receiving member 4 has a rotational axis L21. In the radial direction perpendicular to the rotational axis L21, the auxiliary member 4y is positioned between the engagement portion 44 and the engaged portion 4z. Specifically, the engaged portion 4z includes a connecting portion 41, a chassis 42, and a base 43. The base 43 is connected to at least one of the connecting portion 41 and the chassis 42. In the case where the chassis 42 is not provided, the base 43 will directly connect to the connecting portion 41. As described above, the driving force receiving member 4 may also be viewed as including a main body portion 4x and a connecting portion 41 and/or chassis 42 connected to the main body portion 4x. The main body portion 4x includes a base 43 and an engagement portion 44 that are mutually engaged.

The driving force receiving member 4 includes an engagement portion 44 and a base 43 that are mutually engaged, with the driving force receiving portion 46 disposed in the engagement portion 44. The base 43 is cylindrical and includes a base outer wall 438 and a base inner wall 439 arranged radially and forming a spacing groove 43c therebetween, with a portion of the auxiliary member 4y being accommodated in the spacing groove 43c. Specifically, the base 43 is overall cylindrical and includes a base outer wall 438 and a base inner wall 439 radially arranged. The base outer wall 438 is further away from the rotational axis L21 than the base inner wall 439, and in the radial direction of the driving force receiving member 4, the base outer wall 438 and the base inner wall 439 are spaced apart, forming a spacing groove 43c therebetween. The base inner wall 439 is provided with a protrusion 433 protruding toward the rotational axis L21. The engagement portion 44 is provided with a groove that can mate with the protrusion 433, or the protrusion 433 is provided on the engagement portion 44, and the groove is provided on the base inner wall 439, as long as driving force can be transmitted between the engagement portion 44 and the engaged portion 4z.

The auxiliary member 4y in this embodiment may adopt the structure of the auxiliary member in any of the above embodiments. For example, the auxiliary member 4y includes a carrier body 4y1, a separation member 4y2 protruding from the carrier body 4y1, an elastic arm 4y3 connected to the carrier body 4y1, and a limited portion 4y4 provided on the elastic arm 4y3. The carrier body 4y1 is ring-shaped, enclosing an accommodation cavity 4y6 that can accommodate the engagement portion 44. Preferably, the elastic arm 4y3 is formed by cutting a part of the carrier body 4y1, that is, the elastic arm 4y3 may be viewed as a part of the carrier body 4y1. In this embodiment, at least a portion of the carrier body 4y1 is accommodated in the spacing groove 43c. Thus, in the radial direction of the driving force receiving member 4, the carrier body 4y1 is positioned between the base inner wall 439 and the base outer wall 438.

The engagement portion 44 includes a bottom plate 441, a central column 45 and a driving force receiving portion 46 extending from one side of the bottom plate 441, and a driving force transmission portion 442 extending from the other side of the bottom plate 441. The driving force transmission portion 442 is configured to engage with the protrusion 433 to achieve the transmission of driving force between the engagement portion 44 and the engaged portion 4z. At least a portion of the bottom plate 441 may be viewed as the base portion 461 of the driving force receiving portion 46. The driving force receiving portion 46 further includes a protrusion 462 that is further away from the rotational axis L21/central column 45 than the base portion 461. The protrusion 462 is configured to receive driving force.

Furthermore, the engagement portion 44 further includes a flange portion 47 for guiding the braking portion 203a. Similar to the preferred solution in Embodiment 11, a guide groove 472 is formed between the two flange portions 47, and the face of the flange portion facing the guide groove 472 forms as a positioning guide surface 471. During the engagement process of the driving force receiving member 4 with the force output member 203, the inward protrusion 208e of the braking portion 203a enters the guide groove 472 and is guided by the positioning guide surface 471, determining the relative position of the main body portion 4x of the driving force receiving member 4 with the force output member 203. Ultimately, the driving force receiving member 4 and the force output member 203 can smoothly engage.

In some embodiments, the engagement portion 44 and the engaged portion 4z are formed separately. As shown in FIG. 29, the engagement portion 44 further includes a guide engagement portion 443 disposed on the same side as the driving force transmission portion 442 and a snap-fit protrusion 444 disposed at the end of the guide engagement portion 443. Through the engagement of the snap-fit protrusion 444 with the engaged portion 4z, the engagement portion 44 and the engaged portion 4z achieve engagement. Specifically, the snap-fit protrusion 444 engages with the connecting portion 41 or the chassis 42.

The drive end cover 300 includes an end cover main body 301 and a mounting hole 302 disposed on the end cover main body 301. The driving force receiving member 4 is exposed through the mounting hole 302. The mounting hole 302 has a mounting hole inner surface 3021. As shown in FIG. 30, to more clearly show the internal structure of the driving force receiving member 4 and the drive end cover 300, the figure does not show the engagement portion 44. When the drive end cover 300 is mounted, the base 43 will enter the mounting hole 302. Correspondingly, the base outer wall 438, the base inner wall 439, and the carrier body 4y1 positioned between the base outer wall 438 and the base inner wall 439 will also enter the mounting hole 302.

As described above, the carrier body 4y1 is positioned between the base outer wall 438 and the base inner wall 439, that is, the carrier body outer surface 4y11 will not contact the mounting hole inner surface 3021. As long as it is ensured that the gap between the base outer wall 438 and the base inner wall 439 is larger than the radial dimension of the carrier body 4y1, the auxiliary member 4y having the carrier body 4y1 will be able to rotate freely. At this time, the outer surface of the base outer wall 438 contacts the mounting hole inner surface 3021. Even if the pushing force applied to the charging member 24 by the elastic member 28 is transmitted to the base 43, it will only cause an increase in the friction force between the base 43/base outer wall 438 and the mounting hole inner surface 3021, without affecting the auxiliary member 4y. It can be seen that the resistance when the auxiliary member 4y rotates will not increase, and its rotational flexibility can be maintained.

In some embodiments, the spacing groove 43c is disposed along the entire circumferential direction of the driving force receiving member 4. In this way, the rotation trajectory of the auxiliary member 4y will become more stable.

In other embodiments, along the circumferential direction of the driving force receiving member 4, the spacing groove 43c is only disposed for a predetermined arc. Preferably, the direction of the pushing force applied to the charging member 24 by the elastic member 28 passes through the spacing groove 43c. In other words, in the radial direction of the driving force receiving member 4, the spacing groove 43c is positioned in the direction of the pushing force applied to the charging member 24 by the elastic member 28. This can also ensure that the auxiliary member 4y will not contact the mounting hole inner wall 3021. The resistance when the auxiliary member 4y rotates can be reduced, and its rotational flexibility can be greatly improved. It can be seen that in the radial direction of the driving force receiving member 4, at least a portion of the spacing groove 43c/base outer wall 438 is positioned in the direction of the pushing force applied to the charging member 24 by the elastic member 28, or in other words, at least a portion of the spacing groove 43c/base outer wall 438 is positioned in the direction in which the elastic member 28 pushes the charging member 24.

In other embodiments, the spacing groove 43c may also be disposed on the auxiliary member 4y. Correspondingly, a protrusion for engaging with the spacing groove 4c is disposed on the engaged portion 4z. For example, the above-mentioned base outer wall 438 or base inner wall 439 may be regarded as an embodiment of the protrusion. When the base inner wall 439 engages with the spacing groove 4c disposed on the auxiliary member 4y, the base outer wall 438 may be cancelled. Alternatively, when the base outer wall 438 engages with the spacing groove 4c disposed on the auxiliary member 4y, the outer surface of the carrier body 4y1 will directly face the mounting hole inner wall 3021. Even if the auxiliary member 4y is subjected to the pushing force from the elastic member 28, the resistance when the auxiliary member 4y rotates will not increase, and its rotational flexibility can be maintained.

Furthermore, a lubricant may also be applied between the outer surface of the carrier body 4y1 and the mounting hole inner wall 3021, or the outer surface of the carrier body 4y1 and the mounting hole inner wall 3021 may be disposed as smooth surfaces, thereby reducing the resistance when the auxiliary member 4y rotates.

### Embodiment 14

FIG. 31 is a view illustrating the state after the driving force receiving member according to Embodiment 14 of the present application is separated from the drive end cover; FIG. 32 is a sectional view taken along the direction EE extending through the rotational axis of the driving force receiving member according to Embodiment 14 of the present application.

In this embodiment, the driving force receiving member 4 does not need to undergo the modifications described in Embodiment 13. Correspondingly, the structure of the drive end cover 300 is changed.

As shown in FIGS. 31 and 32, the driving force receiving member 4 has a rotational axis L21 and includes a connecting portion 41, a chassis 42, a base 43, an engagement portion 44, and an auxiliary member 4y that can rotate relative to the engagement portion 44. In the radial direction perpendicular to the rotational axis L21, the dimension of the chassis 42 is larger than the dimensions of the connecting portion 41 and the base 43. The auxiliary member 4y is positioned radially outward from the engagement portion 44, or in other words, the engagement portion 44 is positioned in the accommodation cavity 4y6 of the auxiliary member 4y.

The drive end cover 300 includes an end cover main body 301 and a mounting hole 302 disposed on the end cover main body 301. The driving force receiving member 4 is exposed through the mounting hole 302. Furthermore, the drive end cover 300 further includes a blocking portion 303 extending from the end cover main body 301. When the drive end cover 300 is mounted, at least a portion of the base 43, at least a portion of the auxiliary member 4y, and at least a portion of the engagement portion 44 (not shown in FIG. 32) enter the mounting hole 302. At the same time, the blocking portion 303 abuts against the driving force receiving member 4.

Preferably, the blocking portion 303 abuts against the chassis 42. As shown in FIG. 32, in the radial direction, the blocking portion 303 is positioned radially outward from the mounting hole 302. When the charging member 24 is pressed by the elastic force applied by the elastic member 28 and presses against the photosensitive drum 21, the pressing force received by the driving force receiving member 4 will be eliminated due to the abutment of the blocking portion 303 with the chassis 42. The position of the auxiliary member 4y in the mounting hole 302 will not change, that is, the free rotation state of the auxiliary member 4y will not be affected. Correspondingly, the resistance when the auxiliary member 4y rotates will not increase, and its rotational flexibility can be maintained.

More preferably, along the pushing direction k in which the elastic member 28 applies the pushing force to the charging member 24, the blocking portion 303 abuts against the chassis 42. At this time, the free rotation state of the auxiliary member 4y can be better maintained. It can be seen that in the radial direction of the driving force receiving member 4, at least a portion of the blocking portion 303 is positioned in the direction k of the pushing force applied to the charging member 24 by the elastic member 28, or in other words, at least a portion of the blocking portion 303 is positioned in the pushing direction k in which the elastic member 28 pushes the charging member 24.

In some embodiments, the blocking portion 303 may also be configured to abut against other parts of the driving force receiving member 4. For example, the blocking portion 303 can abut against the connecting portion 41, which can also serve the function of preventing an increase in the resistance when the auxiliary member 4y rotates, thereby maintaining the rotational flexibility of the auxiliary member 4y.

### Embodiment 15

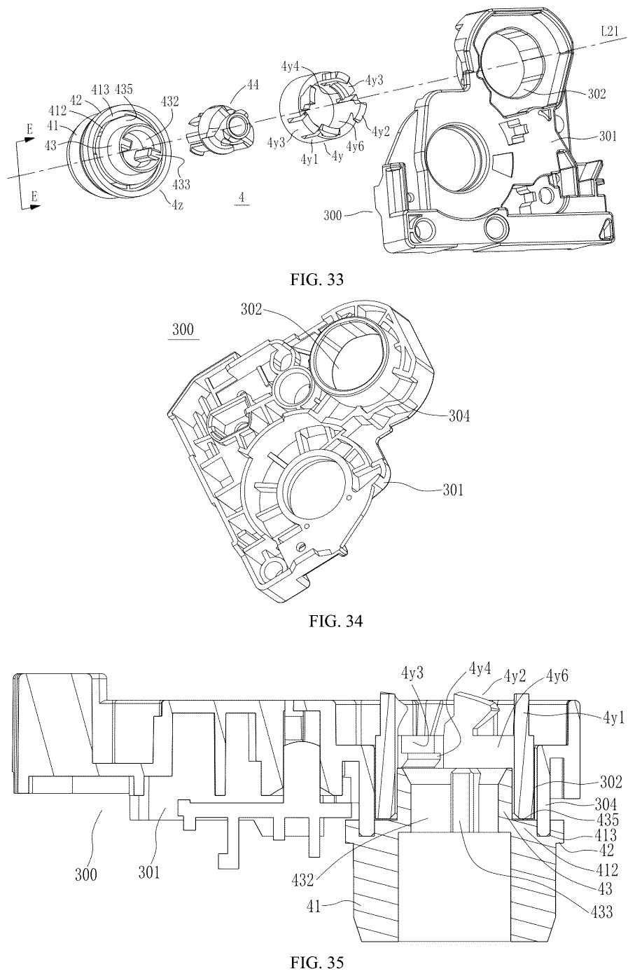

FIG. 33 is an exploded schematic view of the driving force receiving member according to Embodiment 15 of the present application; FIG. 34 is a perspective view of the drive end cover according to Embodiment 15 of the present application; FIG. 35 is a sectional view taken along the direction EE extending through the rotational axis of the driving force receiving member according to Embodiment 15 of the present application.

In this embodiment, the structures of both the driving force receiving member 4 and the drive end cover 300 are changed, but the auxiliary member 4y is not limited and may adopt the structure described in any of the above embodiments. As described above, the driving force receiving member 4 may also be viewed as including an engaged portion 4z and an engagement portion 44 that are mutually engaged, and an auxiliary member 4y that is rotatable relative to the engagement portion 44. The driving force receiving member 4 has a rotational axis L21. The engaged portion 4z includes a connecting portion 41, a chassis 42, and a base 43. The base 43 is connected to at least one of the connecting portion 41 and the chassis 42. In the case where the chassis 42 is not provided, the base 43 will directly connect to the connecting portion 41. The auxiliary member 4y is positioned radially outward from the engagement portion 44, or in other words, the engagement portion 44 is positioned in the accommodation cavity 4y6 of the auxiliary member 4y.

In this embodiment, the structure of the engagement portion 44 is the same as that of the engagement portion in Embodiment 13. The base 43 has a movable cavity 432 formed inside and a protrusion 433 positioned in the movable cavity 432. The engagement portion 44 engages with the base 43 in the same way as in Embodiment 13, which will not be described again here.

Furthermore, the driving force receiving member 4 further includes a base platform 412 disposed in the connecting portion 41 and a first stepped surface 435 disposed on the base platform 412. Along the direction of the rotational axis L21, at least a portion of the base 43 extends from the base platform 412. The engaged portion 4z is also provided with a limiting groove 413. The drive end cover 300 is provided with a limited protrusion 304 that engages with the limiting groove 413. Through the engagement of the limited protrusion 304 with the limiting groove 413, the movement of the photosensitive drum 21 in the radial direction can be limited.

The auxiliary member 4y is supported by the first stepped surface 435. In the radial direction of the driving force receiving member 4, the limiting groove 413 is positioned radially outward from the auxiliary member 4y. Therefore, the position of the auxiliary member 4y in the mounting hole 302 will not change, and the free rotation state of the auxiliary member 4y will not be affected. Correspondingly, the resistance when the auxiliary member 4y rotates will not increase, and its rotational flexibility can be guaranteed.

Specifically, the limiting groove 413 may be disposed either on the connecting portion 41 or on the chassis 42. In the radial direction, the limiting groove 413 is positioned radially outward from the base 43, or in other words, the limiting groove 413 is further away from the rotational axis L21 than the base 43, and in the radial direction, the first stepped surface 435 is formed between the limiting groove 413 and the base 43. As shown in FIG. 34, the drive end cover 300 includes an end cover main body 301, a mounting hole 302 disposed on the end cover main body 301, and a limited protrusion 304 extending from the end cover main body 301. The limited protrusion 304 is configured to engage with the limiting groove 413. Preferably, the limited protrusion 304 is formed extending along the direction of the rotational axis L21 from the radial edge of the mounting hole 302, that is, the limited protrusion 304 surrounds and forms the mounting hole 302.

In some embodiments, the positions of the limiting groove 413 and the limited protrusion 304 may also be interchanged, that is, the limiting groove 413 is disposed on the drive end cover 300, and the limited protrusion 304 is disposed on the engaged portion 4z. Like the above embodiments, in the radial direction of the driving force receiving member 4, at least a portion of one of the limiting groove 413 and the limited protrusion 304 is positioned in the direction of the pushing force applied to the charging member 24 by the elastic member 28, or in other words, at least a portion of one of the limiting groove 413 and the limited protrusion 304 is positioned in the direction in which the elastic member 28 pushes the charging member 24.

In summary, in the radial direction of the driving force receiving member 4, by setting a limiting member and a limited member that can engage with each other, it can be prevented that when the elastic member 28 applies a force to the charging member 24 to approach the photosensitive drum 21, the driving force receiving member 4, which is coaxially disposed with the photosensitive drum 21, is indirectly pushed, thereby causing the auxiliary member 4y positioned on the driving force receiving member 4 to be pressed against the mounting hole inner wall 3021 of the drive end cover 300, or causing the auxiliary member 4y to be pressed against the engagement portion 44/main body portion 4x, resulting in an increase in the rotation resistance of the auxiliary member 4y, a decrease in the rotation flexibility of the auxiliary member 4y, and finally, the driving force receiving member 4 not being able to smoothly engage with the force output member 203.

Based on the inventive concept of the present application, in the radial direction of the driving force receiving member 4, the carrier body outer surface 4y11 of the auxiliary member 4y is disposed not to contact the mounting hole inner wall 3021, that is, a gap is formed between the outer surface 4y11 and the mounting hole inner wall 3021, or even if the outer surface 4y11 contacts the mounting hole inner wall 3021, they do not press against each other. In this way, the rotation resistance of the auxiliary member 4y will not increase, the rotation flexibility of the auxiliary member 4y can be maintained, and thus the driving force receiving member 4 and the force output member 203 can smoothly engage.

After the limiting member and the limited member engage with each other, even if the driving force receiving member 4 indirectly receives the force from the elastic member 28, the auxiliary member 4y will not be pressed against the mounting hole inner wall 3021, or the auxiliary member 4y will not be pressed against the engagement portion 44/main body portion 4x. The friction force between the auxiliary member 4y and the mounting hole inner wall 3021 and/or the friction force between the auxiliary member 4y and the engagement portion 44/main body portion 4x will not increase. Therefore, the resistance when the auxiliary member 4y rotates will not increase, and the rotation flexibility of the auxiliary member 4y can be maintained.

Preferably, along the approaching direction k in which the elastic member 28 forces the charging member 24 to approach the photosensitive drum 21, at least a portion of one of the limited member and the limiting member is positioned in the approaching direction k, that is, in the radial direction of the driving force receiving member, the limiting member and the limited member engage at least in the approaching direction k.

According to Embodiments 13 and 14, the limited member may be the spacing groove 43c disposed on the engaged portion 4z, or the chassis 42/connecting portion 41 disposed on the engaged portion 4z, or the limiting groove 413 disposed on the engaged portion 4z. The limiting member may be a part of the auxiliary member 4y itself, or the blocking portion 303 disposed on the drive end cover 300, or the limited protrusion 304 disposed on the drive end cover 300. In modifiable embodiments, the positions of the limiting member and the limited member may be interchanged.

As described above, the charging member 24 is configured to charge the photosensitive drum. Correspondingly, the process cartridge C is also provided with a charging electrode for receiving electrical power from the imaging device and supplying it to the charging member 24 (The term “charging electrode” and “power receiving portion” referred to in this specification refer to the same component). The top plate 94 is also provided with a power output member that can make electrical contact with the charging electrode. As the door cover closes, the top plate 94 moves downward and abuts against the process cartridge C, the power output member makes electrical contact with the charging electrode, and finally, the process cartridge C is positioned in the imaging device. At the same time, the charging electrode can receive the electrical power output by the power output member. Conversely, when the door cover opens, the top plate moves upward away from the process cartridge C, and the charging electrode loses contact with the power output member.

Generally, the process cartridge C is also provided with a chip that can establish a communication connection with the imaging device. The top plate 94 is provided with a contact pin that can make electrical contact with the chip. The contact pin is configured to be retractable. As the top plate 94 moves downward, the contact pin abuts against the chip, achieving electrical contact. To simplify the complexity of the internal circuits of the imaging device, the chip and the charging electrode are disposed at the same longitudinal end of the process cartridge. When the process cartridge is installed in the predetermined position, the electrical contact portion in the chip for making electrical contact with the contact pin and the charging electrode are both fixed in a way that faces upward (the top plate). In this way, the contact between the contact pin and the electrical contact portion, as well as the contact between the power output member and the charging electrode, can be achieved simultaneously.

However, to achieve stable electrical connection between the process cartridge and the imaging device, that is, stable contact between the contact pin and the electrical contact portion as well as stable contact between the power output member and the charging electrode, it is necessary to ensure that the installation position of the charging electrode is precise. Otherwise, it is difficult to simultaneously achieve contact between the contact pin and the electrical contact portion as well as contact between the power output member and the charging electrode.

For this purpose, the present application also provides the following embodiments to enhance stable electrical connection between the process cartridge and the imaging device. It should be understood that those skilled in the art can also combine at least any one of the following embodiments with at least any one of the above embodiments according to design requirements. The following description will use the above-mentioned imaging device with a drawer-type accommodation portion and the process cartridge C applicable to it as an example.

Regarding the structure of the process cartridge C, structures that are the same as those in the above embodiments will not be described again.

The process cartridge C further includes a chip C7 for establishing a communication connection with the imaging device. The chip C7 includes a storage portion for storing process cartridge information and an electrical contact portion C71 electrically connected to the storage portion. The electrical contact portion C71 and the storage portion may either be integrated on the same board or disposed separately, but the electrical contact portion C71 always faces upward and is exposed toward the upper side of the process cartridge. When the door cover closes, the electrical contact portion C71 makes electrical contact with the contact pin 95.

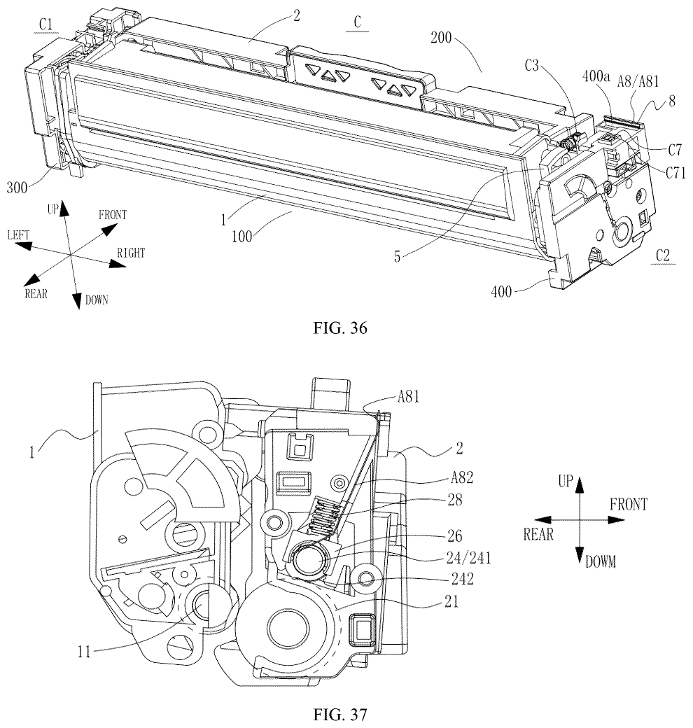

Furthermore, the process cartridge C further includes a charging electrode assembly 8 (as shown in FIG. 36) for supplying electrical power to the charging member 24. The charging electrode assembly 8 is configured to make electrical contact with the power output member 96. The charging member 24 is rotatably supported by a bracket 26. A spring 28 is disposed between the bracket 26 and the second unit housing 2. Through the pushing of the spring 28, the charging member 24 maintains contact with the photosensitive drum 21. When the process cartridge C operates, the metal shaft 241 receives electrical power from the imaging device, causing the charging member 24 to charge the surface of the photosensitive drum 21. When a laser beam carrying imaging information illuminates the charged surface of the photosensitive drum, an electrostatic latent image is formed in the area needing imaging. Subsequently, the developer on the surface of the developing roller 11 develops the electrostatic latent image. In some embodiments, the charging electrode assembly 8 supplies power to the charging member 24 by directly abutting against the metal shaft 241. In other embodiments, the bracket 26 may be made of conductive material. In this way, the charging electrode assembly 8 supplies power to the charging member 24 by abutting against the spring 28 or the bracket 26. Hereinafter, the description of the electrical connection between the charging electrode assembly 8 and the charging member 24 includes any of the three abutment methods mentioned above.

Preferably, the electrical contact portion C71 and the charging electrode assembly 8 are disposed at the non-drive end C2. As can be understood, the electrical contact portion C71 and the power receiving portion A81 are disposed at the non-drive end. On one hand, this can prevent vibrations at the drive end from making the electrical contact between the electrical contact portion C71 and the contact pin 95, as well as the electrical contact between the charging electrode assembly 8 and the power output member 96, unstable. On the other hand, it can simplify the complexity of the circuits inside the imaging device, making the components (such as the above-mentioned contact pin 95 and power output member 96) in the imaging device for supplying power to the process cartridge all disposed at the non-drive end C2 of the process cartridge C.

In some embodiments, the setting positions of the electrical contact portion C71 and the charging electrode assembly 8 should not be limited. For example, the electrical contact portion C71 and the charging electrode assembly 8 may be disposed separately or together on any one of the first unit housing 1, the second unit housing 2, and the second end cover 400.

The electrical contact portion C71 is disposed on the second end cover 400. When it is difficult to disassemble the chip C7 due to the need to replace it, the chip C7 and the second end cover 400 can be replaced together directly. Moreover, since the electrical contact portion C71 is disposed on the second end cover 400, the chip C7 and the second end cover 400 can be assembled into an assembly in advance during the assembly of the process cartridge.

The charging electrode assembly 8 is disposed on the second unit housing 2, resulting in a more compact overall layout and facilitating easier assembly. Moreover, the second unit housing 2, relative to the second end cover 400, serves as a more stable installation platform for the charging electrode assembly 8, reducing the likelihood of displacement caused by external vibrations and thereby further enhancing the stability of the electrical connection.

Compared to the existing technology where the power receiving portion A81 is disposed on the side of the end cover of the process cartridge, this embodiment innovatively integrates the charging electrode assembly 8 into the second unit housing 2 and fixes the power receiving portion A81 in a manner of facing upward (towards the top plate). This design eliminates the need to open an electrode exposure port on the second end cover 400, thereby avoiding structural weaknesses caused by openings. This not only simplifies the design and manufacturing process of the end cover but also significantly enhances the overall strength and impact resistance of the second end cover 400, improving the reliability and service life of the device.

The following description will use an example where the electrical contact portion C71 and the charging electrode assembly 8 are both disposed on the second end cover 400.

### Embodiment 16

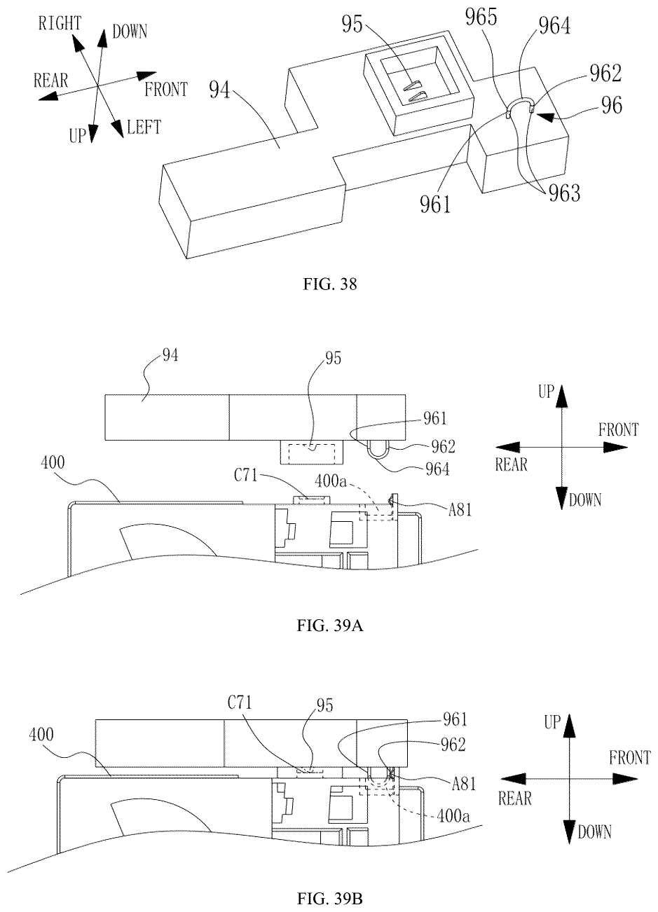

FIG. 36 is a perspective view of the process cartridge when viewed from the non-drive end of the process cartridge according to Embodiment 16 of the present application; FIG. 37 is a side view when viewed from left to right in the left-right direction after hiding some components of the process cartridge according to Embodiment 16 of the present application; FIG. 38 is a perspective view of the top plate in the imaging device applicable to the process cartridge according to the present application; FIG. 39A is a simplified side view when viewed from left to right in the left-right direction before the process cartridge according to Embodiment 16 of the present application contacts the top plate; FIG. 39B is a simplified side view when viewed from left to right in the left-right direction after the process cartridge according to Embodiment 16 of the present application contacts the top plate.

Before describing the process cartridge in this embodiment, the power output member 96 will first be described. As shown in FIG. 38, based on the state where the process cartridge C is installed in the imaging device, the top plate 94 also has the above-mentioned up-down direction, left-right direction, and front-rear direction. The contact pin 95 and the power output member 96 are both exposed downward. The number of contact pins 95 corresponds to the number of electrical contact portions C71 of the chip 7. The power output member 96 is configured as a conductor protruding downward from the top plate 94, having a front conductive surface 962 facing forward, a rear conductive surface 961 facing rearward, a left conductive surface 963 facing leftward, a right conductive surface 965 facing rightward, and a lower conductive surface 964 facing downward.

As shown in FIG. 37, the charging electrode assembly A8 includes a power receiving portion A81 for receiving electrical power and a power transmission portion A82 for making electrical connection with the charging member 24. The power receiving portion A81 is electrically connected to the power transmission portion A82. Preferably, the power receiving portion A81 and the power transmission portion A82 are integrally formed. In this embodiment, the power receiving portion A81 and the power transmission portion A82 are integrally formed from conductive material.

As shown in FIG. 36, the electrical contact portion C71 and the power receiving portion A81 are disposed at the upper portion of the non-drive end and are exposed upward from the housing. As shown in FIG. 37, the developing roller 11 is rotatably mounted in the housing of the process cartridge C, the photosensitive drum 21 and the developing roller 11 are mounted in a lower side of the housing. Furthermore, the second end cover 400 is further provided with an electrical contact cavity 400a. When the door cover of the imaging device closes, at least the power receiving portion A81 is positioned in the electrical contact cavity 400a. In this embodiment, the power receiving portion A81 is fixedly installed in the electrical contact cavity 400a, specifically, the power receiving portion A81 is fixed at the front side of the electrical contact cavity 400a. During the downward movement of the top plate 94, at least a portion of the power output member 96 enters the electrical contact cavity 400a, and the electrical contact cavity 400a plays a positioning and guiding role for the power output member 96, ensuring accurate connection between the power output member 96 and the power receiving portion A81 and maintaining good electrical contact to maintain good print quality.

Before the door cover of the imaging device closes, the top plate 94 is in the position shown in FIG. 39A. At this time, along the up-down direction, the top plate 94 does not abut against the process cartridge C, the contact pin 95 and the electrical contact portion C71 are separated from each other, and the power output member 96 and the power receiving portion A81 are also separated from each other. As the door cover of the imaging device closes, the top plate 94 gradually moves downward. When the door cover is completely closed, the top plate 94 abuts against the process cartridge C, the contact pin 95 abuts against the electrical contact portion C71 and retracts toward the interior of the top plate 94, at least a portion of the power output member 96 enters the electrical contact cavity 400a, and the front conductive surface 962 contacts the power receiving portion A81. Finally, the electrical contact portion C71 and the contact pin 95 achieve electrical connection, and the power receiving portion A81 and the power output member 96 also achieve electrical connection. The electrical connection between the process cartridge and the imaging device will also become stable. At the same time, utilizing the abutment of the contact pin 95 against the electrical contact portion C71, the process cartridge C can be stably positioned in the imaging device.

As a modified form of this embodiment, the power receiving portion A81 may also be disposed at the rear side of the electrical contact cavity 400a. When at least a portion of the power output member 96 enters the electrical contact cavity 400a, the rear conductive surface 961 of the power output member 96 contacts the power receiving portion A81. At this time, the action force that the power receiving portion A81 can apply to the power output member 96 will be directed forward. This method can also ensure that the electrical connection between the process cartridge and the imaging device becomes stable.

As described above, when the door cover closes and the top plate 94 abuts against the process cartridge C, at least a portion of the power output member 96 enters the electrical contact cavity 400a, and the power receiving portion A81 abuts against the side conductive surface (not the lower conductive surface) of the power output member 96. The possible action force that the power receiving portion A81 may apply to the power output member 96 is directed rearward. The top plate 94 will only be subjected to the upward reaction force applied by the electrical contact portion C71 to the contact pin 95. Therefore, the contact between the electrical contact portion C71 and the contact pin 95, as well as the contact between the power receiving portion A81 and the power output member 96, can be stably achieved. The electrical connection between the process cartridge and the imaging device will also become stable.

### Embodiment 17

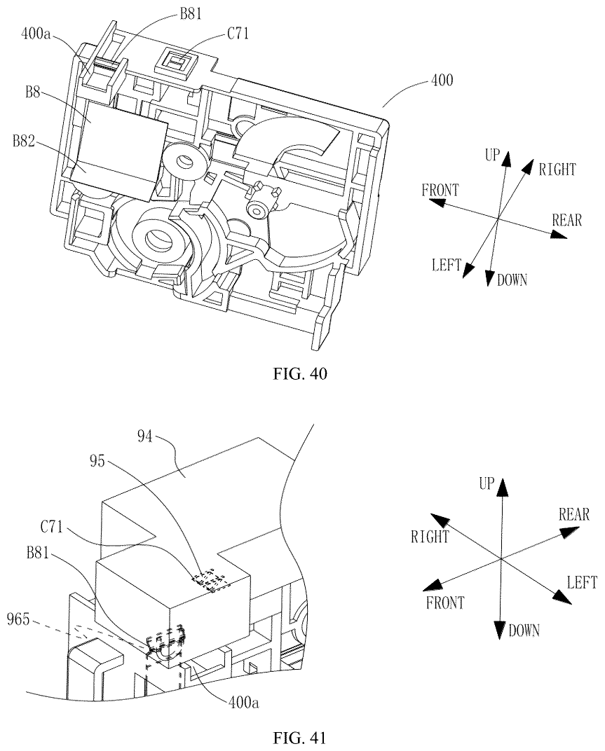

FIG. 40 is a perspective view of some components in the process cartridge according to Embodiment 17 of the present application; FIG. 41 is a partial perspective view of the process cartridge according to Embodiment 17 of the present application after contacting the top plate.

Compared to Embodiment 16, the contact position between the charging electrode assembly B8 and the power output member 96 in this embodiment is different. As shown in FIG. 40, the power receiving portion B81 is fixedly installed on the right side of the electrical contact cavity 400a. As shown in FIG. 41, when the top plate 94 moves downward and abuts against the process cartridge C, at least a portion of the power output member 96 enters the electrical contact cavity 400a, the contact pin 95 makes electrical connection with the electrical contact portion C71, and at the same time, the right conductive surface 965 of the power output member 96 contacts the power receiving portion B81, achieving electrical connection.

Similarly, in this embodiment, the possible action force that the power receiving portion B81 may apply to the power output member 96 is directed leftward. The top plate 94 will only be subjected to the upward reaction force applied by the electrical contact portion C71 to the contact pin 95. Therefore, the contact between the electrical contact portion C71 and the contact pin 95, as well as the contact between the power receiving portion B81 and the power output member 96, can be stably achieved. The electrical connection between the process cartridge and the imaging device will also become stable.

As a modified form of this embodiment, the power receiving portion B81 may also be disposed on the left side of the electrical contact cavity 400a. When at least a portion of the power output member 96 enters the electrical contact cavity 400a, the left conductive surface 963 of the power output member 96 contacts the power receiving portion B81. At this time, the possible action force that the power receiving portion B81 may apply to the power output member 96 will be directed rightward. This method can also ensure that the electrical connection between the process cartridge and the imaging device becomes stable.

### Embodiment 18

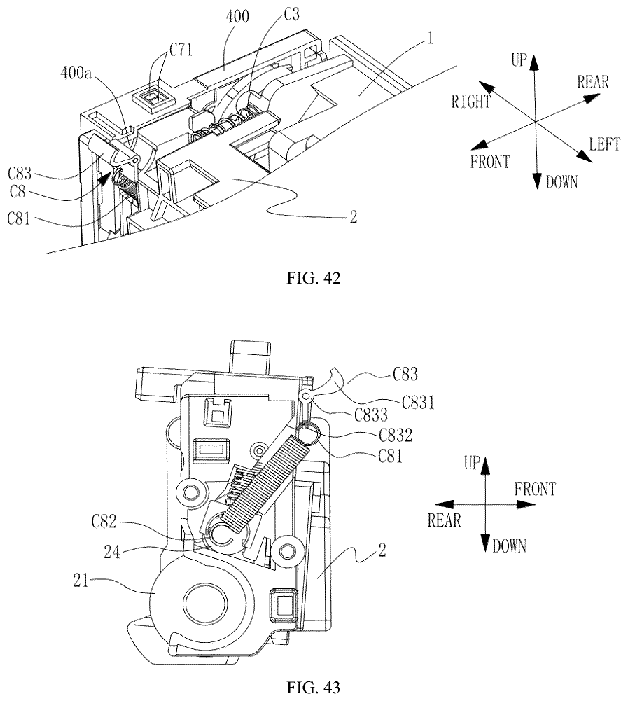

FIG. 42 is a perspective view of some components in the process cartridge according to Embodiment 18 of the present application; FIG. 43 is a simplified side view when viewed from left to right in the left-right direction after hiding some components before the process cartridge according to Embodiment 18 of the present application contacts the top plate; FIG. 44 is a simplified side view when viewed from left to right in the left-right direction after the process cartridge according to Embodiment 18 of the present application contacts the top plate.

As shown, the charging electrode assembly C8 in this embodiment includes a power receiving portion C81, a power transmission portion C82, and a toggle member C83. The toggle member C83 is configured to toggle the power receiving portion C81, causing the power receiving portion C81 to transition from a first state where it cannot receive power to a second state where it can receive power. Thus, the electrical power from the power output member 96 is transmitted to the charging member 24 sequentially through the toggle member C83, the power receiving portion C81, and the power transmission portion C82, or the electrical power is transmitted to the charging member 24 sequentially through the power receiving portion C81 and the power transmission portion C82.

In this embodiment, the toggle member C83 is configured to be rotatable about a rotation axis. This rotation axis should not be limited, for example, the rotation axis may be parallel to the left-right direction, may be parallel to the front-rear direction, and may also be parallel to the up-down direction. The power receiving portion C81 and the power transmission portion C82 are configured as an integrally formed tension spring, with the power receiving portion C81 and the power transmission portion C82 being the two ends of the tension spring. Among them, the power receiving portion C81 is connected to the toggle member C83, and the power transmission portion C82 is electrically connected to the charging member 24.

This embodiment uses an example where the rotation axis of the toggle member C83 is parallel to the left-right direction, and the toggle member C83 is made of non-conductive material. As shown in the figure, the toggle member C83 includes a pressed portion C831, a toggle portion C832, and a rotation portion C833. The pressed portion C831 and the toggle portion C832 protrude from the rotation portion C833. Before the door cover closes, or in other words, before the top plate 94 abuts against the process cartridge C, the power receiving portion C81 is pulled upward by the tension spring (power receiving portion C81), and the pressed portion C831 points downward. Preferably, the pressed portion C831 protrudes from the second unit housing 2. When the top plate 94 begins to abut against the process cartridge C, the pressed portion C831 is pressed by the top plate 94 and rotates about the rotation axis, the pressed portion C831 moves upward, and simultaneously, the toggle portion C832 drives the power receiving portion C81 to move downward; when the door cover is completely closed, the pressed portion C831 is pressed by the top plate 94 to the lowermost position, at least a portion of the power output member 96 enters the electrical contact cavity 400a, the toggle portion C832 drives the power receiving portion C81 to contact the power output member 96, and simultaneously, the contact pin 95 is electrically connected to the electrical contact portion C71; the power receiving portion C81 may contact any one of the side conductive surfaces of the power output member 96 (including the conductive surface 962, the rear conductive surface 961, the left conductive surface 963, and the right conductive surface 965), at this time, any potential force applied by the power receiving portion C81 to the power output member 96 is not directed upward, therefore, the contact between the electrical contact portion C71 and the contact pin 95 as well as the contact between the power receiving portion C81 and the power output member 96 can be stably achieved, and the electrical connection between the process cartridge and the imaging device also becomes stable.

It should be noted that in this embodiment, the power receiving portion C81 may also contact the lower conductive surface 964 of the power output member 96. In this case, although the possible action force that the power receiving portion C81 may apply to the power output member 96 will be directed upward, the power receiving portion C81 is one end of the tension spring. Therefore, even if the downward pressing force applied by the power output member 96 to the power receiving portion C81 is relatively large, the power receiving portion C81 can also absorb this relatively large pressing force by contracting downward, making the contact between the power output member 96 and the power receiving portion C81 not weaken the electrical connection between the electrical contact portion C71 and the contact pin 95. Therefore, in this case, the contact between the electrical contact portion C71 and the contact pin 95, as well as the contact between the power receiving portion C81 and the power output member 96, can also be stably achieved. The electrical connection between the process cartridge and the imaging device also becomes stable.

### Embodiment 19

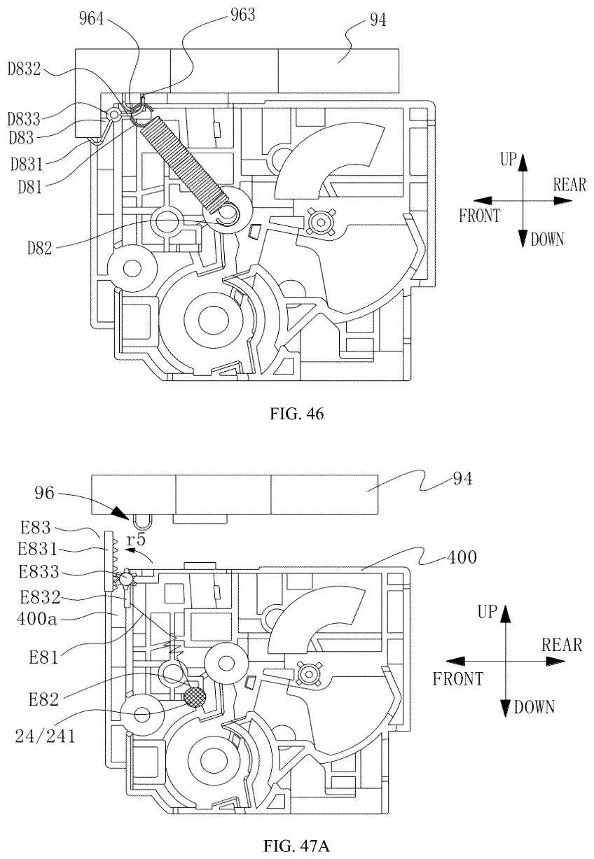

FIG. 45 is a perspective view of some components in the process cartridge according to Embodiment 19 of the present application; FIG. 46 is a simplified side view when viewed from left to right in the left-right direction after the process cartridge according to Embodiment 19 of the present application contacts the top plate.

Compared to Embodiment 18, the toggle member D83 in this embodiment is made of metal. Therefore, in this embodiment, when the top plate 94 abuts against the process cartridge C, the toggle member D83 does not need to toggle the power receiving portion D81 to contact the power output member 96. Instead, the toggle member D83 itself contacts the power output member 96, and then the toggle member D83 transmits the electrical power to the power receiving portion D81. Preferably, the toggle portion D832 of the toggle member D83 contacts the power output member 96. In this way, the movement path of the power receiving portion D81 in the process cartridge C can be reduced, or even the power receiving portion D81 does not need to move. It only needs to ensure that the power receiving portion D81 can maintain good electrical contact with the movable toggle member D83.

Similar to Embodiment 18, when the top plate 94 abuts against the process cartridge C, at least a portion of the power output member 96 enters the electrical contact cavity 400a, and the toggle member D83 may contact any one of the conductive surfaces of the power output member 96. Preferably, the toggle portion D832 of the toggle member D83 contacts the side conductive surface of the power output member 96. Therefore, the contact between the electrical contact portion C71 and the contact pin 95, as well as the contact between the power receiving portion D81 and the power output member 96, can be stably achieved. The electrical connection between the process cartridge and the imaging device also becomes stable.

### Embodiment 20

FIGS. 47A and 47B are simplified side views when viewed from left to right in the left-right direction before and after the process cartridge according to Embodiment 20 of the present application contacts the top plate, respectively.

In this embodiment, the charging electrode assembly E8 includes a power receiving portion E81, a power transmission portion E82, and a toggle member E83. The power transmission portion E82 is electrically connected to the charging member 24. The toggle member E83 is configured to transition the power receiving portion E81 from a first state where it cannot receive power to a second state where it can receive power. Different from Embodiments 18 and 19, at least a portion of the toggle member E83 in this embodiment is configured as a rack that can slide along the up-down direction.

As shown, the toggle member E83 includes a rack E831, a toggle portion E832, and a rotation portion E833. The rack E831 extends along the up-down direction, and the toggle portion E832 protrudes from the rotation portion E833. The rack E831 and the rotation portion E833 are provided with teeth that can mesh with each other. At the same time, the power receiving portion E81 is connected to the toggle member E83/toggle portion E832, and the power transmission portion E82 is electrically connected to the charging member 24.

According to the descriptions in Embodiments 18 and 19, the toggle portion E832 may be made of either conductive material or non-conductive material. Before the top plate 94 abuts against the process cartridge C, preferably, the rack E831 protrudes upward from the second end cover 400/second unit housing 2. As the top plate 94 approaches the process cartridge C downward, the upper end of the rack E831 begins to be pressed by the top plate 94, the rack E831 moves downward, then the rotation portion E833 rotates in the direction r5 shown, and the toggle portion E832 itself or the toggle portion E832 carrying the power receiving portion E81 moves upward. As shown in FIG. 47B, when the top plate 94 presses the rack E831 to move to the lowermost position, at least a portion of the power output member 96 enters the electrical contact cavity 400a, the toggle portion E832 brings the power receiving portion E81 into contact with the power output member 96, or the toggle portion E832 itself contacts the power output member 96, and at the same time, the contact pin 95 makes electrical connection with the electrical contact portion C71. The power receiving portion E81/toggle portion E832 may contact any one of the conductive surfaces of the power output member 96. Therefore, the contact between the electrical contact portion C71 and the contact pin 95, as well as the contact between the power receiving portion E81 and the power output member 96, can be stably achieved. The electrical connection between the process cartridge and the imaging device also becomes stable.

### Embodiment 21

FIGS. 48A and 48B are simplified side views when viewed from left to right in the left-right direction before and after the process cartridge according to Embodiment 21 of the present application contacts the top plate, respectively.

Compared to Embodiment 20, the toggle portion F832 of the toggle member F83 in this embodiment is also configured as a rack. The rotation portion F833 is positioned between the rack F831 and the rack F832. The toggle portion F832 may be made of either conductive material or non-conductive material. The power receiving portion F81 is connected to the rack F832. The rack F832 is configured to transition the power receiving portion F81 from a first state where it cannot receive power to a second state where it can receive power. During the process of the top plate 94 approaching the process cartridge C, at least a portion of the power output member 96 gradually enters the electrical contact cavity 400a, the rack F831 gradually moves downward, through the rotation portion F833, the rack F832 gradually moves upward, and finally, the power receiving portion F81 contacts the power output member 96, or the rack F832 itself contacts the power output member 96, and at the same time, the contact pin 95 makes electrical connection with the electrical contact portion C71. The power receiving portion F81/toggle portion F832 may contact any one of the conductive surfaces of the power output member 96. Therefore, the contact between the electrical contact portion C71 and the contact pin 95, as well as the contact between the power receiving portion F81 and the power output member 96, can be stably achieved. The electrical connection between the process cartridge and the imaging device also becomes stable.

As a modified form of the above embodiments, at least a portion of a separation contact mechanism 5 can also serve as the toggle member. During the process of the top plate 94 moving toward the process cartridge C, the top plate 94 interacts with the separation contact mechanism 5, forcing at least a portion of the separation contact mechanism 5 to move. This portion of the separation contact mechanism 5 causes the power receiving portion to transition from a first state where it cannot receive power to a second state where it can receive power.

What is claimed is:

1. A process cartridge detachably installable in an imaging device, comprising:
a driving force receiving member;
a housing, comprising a drive end where the driving force receiving member is provided and an opposite non-drive end;
a photosensitive drum, rotatably mounted in the housing, wherein the photosensitive drum is driven by driving force received by the driving force receiving member, and the driving force receiving member is exposed from the drive end;
a charging member, configured to charge the photosensitive drum;
a charging electrode assembly, comprising a power receiving portion configured to receive electrical power and a power transmission portion configured to make electrical connection with the charging member, wherein the power receiving portion is electrically connected to the power transmission portion;
a chip, comprising a storage portion for storing process cartridge information and an electrical contact portion electrically connected to the storage portion; and
a developing roller, rotatably mounted in the housing, with the photosensitive drum and the developing roller being mounted in a lower side of the housing;
wherein the electrical contact portion and the power receiving portion are disposed at an upper portion of the non-drive end, and are exposed upward from the housing.

2. The process cartridge according to claim 1, wherein the housing comprises a first unit housing, a second unit housing, and a second end cover mounted at the non-drive end, the second end cover engages with the first unit housing and the second unit housing, the electrical contact portion is disposed on the second end cover, and the charging electrode assembly is disposed on the second unit housing.

3. The process cartridge according to claim 1, wherein the electrical contact portion and the power receiving portion both face upward.

4. The process cartridge according to claim 1, wherein the housing comprises a first unit housing, a second unit housing, and a second end cover mounted at the non-drive end, the second end cover engages with the first unit housing and the second unit housing, the second end cover is further provided with an electrical contact cavity, and at least the power receiving portion is positioned in the electrical contact cavity.

5. The process cartridge according to claim 1, wherein the imaging device further comprises a door cover, and a top plate provided with a power output member and a contact pin, the contact pin and the power output member are both exposed downward, before the door cover of the imaging device closes, the top plate does not abut against the process cartridge, when the door cover closes, the top plate abuts against the process cartridge, the electrical contact portion achieves electrical connection with the contact pin, and the power receiving portion also achieves electrical connection with the power output member.

6. The process cartridge according to claim 5, wherein the power receiving portion contacts either a lower conductive surface or a side conductive surface of the power output member.

7. The process cartridge according to claim 1, further comprising a toggle member configured to toggle the power receiving portion, causing the power receiving portion to transition from a first state where the power receiving portion is not capable of receiving power to a second state where the power receiving portion is capable of receiving power.

8. The process cartridge according to claim 1, wherein the charging member is rotatably supported by a bracket on the housing, a spring is disposed between the bracket and the housing, and through pushing of the spring, the charging member maintains contact with the photosensitive drum.

9. The process cartridge according to claim 1, further comprising a friction member disposed adjacent to and in contact with the charging member, wherein the friction member extends along a direction of a rotational axis of the driving force receiving member, and the charging member is rotatably supported by a bracket on the housing.

10. The process cartridge according to claim 9, wherein the charging member is driven to rotate by a friction force between a surface of the photosensitive drum and a surface of the charging member, and when the charging member loses its drive source, a friction force between the friction member and the charging member forces the charging member, which continues to rotate due to inertia, to stop rotating.

11. The process cartridge according to claim 9, wherein the friction member is an elastic component.

12. The process cartridge according to claim 9, wherein the friction member is configured as a sponge body.

13. The process cartridge according to claim 1, wherein the imaging device further comprises a force output member, the force output member comprises a driving portion and a braking portion, and the braking portion is rotatable together with the driving portion, the driving force receiving member comprises a driving force receiving portion and an auxiliary member, the driving force receiving portion is configured to engage with the force output member to receive driving force, the auxiliary member is configured to rotate freely about a rotational axis of the driving force receiving member, and at least a portion of the auxiliary member is configured to separate the driving portion and the braking portion in a rotational direction of the force output member.

14. The process cartridge according to claim 13, wherein the auxiliary member is movably disposed along a direction of the rotational axis of the driving force receiving member.

15. The process cartridge according to claim 13, wherein the driving force receiving member further comprises a main body portion provided with the driving force receiving portion, at least a portion of the main body portion is accommodated by the auxiliary member; the auxiliary member is provided with a limited portion, and the main body portion is provided with a limiting portion configured to engage with the limited portion.

16. The process cartridge according to claim 15, wherein the auxiliary member comprises a carrier body and a separation member protruding from the carrier body, the limited portion is disposed on the carrier body or the separation member, the auxiliary member is sleeved on the outside of the main body portion, the separation member is provided with a guide surface, and during a process of the driving force receiving member moving toward the force output member, the guide surface abuts against the braking portion and forces the braking portion to move away from the driving portion along the rotational direction.

17. The process cartridge according to claim 16, wherein the separation member is further provided with a hook surface configured to engage with the braking portion, the hook surface is configured to prevent the force output member from separating from the driving force receiving member.

18. The process cartridge according to claim 16, wherein the separation member comprises a separation member body and a tip portion that are mutually engaged, the guide surface is disposed on the separation member body, and the tip portion extends from the guide surface in a direction further away from the carrier body.

19. The process cartridge according to claim 13, wherein the auxiliary member is sleeved on the housing.

20. The process cartridge according to claim 13, wherein when the driving force receiving member and the force output member are fully engaged, at least a portion of the auxiliary member enters a space between the driving portion and the braking portion, and the driving force receiving portion engages with the driving portion or the braking portion.
